(19) United States
(12) Patent Application Publication
(10) Pub. No.: US 2012/0120207 A1
(43) Pub. Date: May 17, 2012

(54) IMAGE PLAYBACK DEVICE AND DISPLAY DEVICE

(76) Inventors: Hiroaki Shimazaki, Osaka (JP); Kenjiro Tsuda, Kyoto (JP); Tatsuro Juri, Osaka (JP); Hiromichi Ono, Osaka (JP)

(21) Appl. No.: 13/387,198

(22) PCT Filed: Dec. 6, 2010
(86) PCT No.: PCT/JP2010/007088

§ 371 Date: Jan. 26, 2012

(30) Foreign Application Priority Data
Dec. 28, 2009 (JP) 2009-298202

(51) Int. Cl. H04N 13/04

(52) U.S. Cl. 348/51; 348/E13.026

(57) ABSTRACT

An image playback device includes a playback portion which plays back content data to make a video stereoscopically viewed by means of video data including first and second images for first and second view points, respectively; a setting portion which sets a playback speed for playing back the content data; and an adjuster which adjusts parallax information about parallax between the first and second images in response to the playback speed set by the setting portion.

### TECHNICAL FIELD

The present invention is related to an image playback device and a display device for playing back content data so that a viewer views stereoscopic images.

### BACKGROUND OF THE INVENTION

Technologies for providing a viewer with stereoscopic images have been proposed due to development of video image technologies in recent years. Content data for presenting a viewer with stereoscopic images generally include a left image which is viewed by the left eye and a right image which is viewed by the right eye. For example, the left image represents an image displayed in a vision field expanding from a view point at the left eye of the viewer and the right image represents an image displayed in a view field expanding from a view point at the right eye of the viewer.

If content data are played back, these images are alternately displayed on a display. Meanwhile, the viewer wears a dedicated eyeglass device to view the stereoscopic images on the display. While the left image is displayed on the display, the eyeglass device shuts off light transmission to the right eye whereas the eyeglass device permits light transmission to the left eye. While the right image is displayed on the display, the eyeglass device shuts off light transmission to the left eye whereas the eyeglass device permits light transmission to the right eye. The viewer processes a difference (parallax) between the displayed images onto the retinas of the right and left eyes in the brain to perceive objects popping up or deeps in. If the parallax amount is small, the image is perceived as being situated close to the display surface. If the parallax amount is large, the image is perceived as being situated at a distant position from the display surface. Therefore, the viewer may stereoscopically view the objects in the displayed images on the display.

Like the playback of content data for presenting normal two-dimensional images, there are needs for fast playback of the content data for presenting stereoscopic images as well. In the fast playback which is carried out to figure out a playback point for viewing in the normal playback, video images of the content data are played back without audio at a faster speed than the standard playback speed, which depends on a recording medium to store the content data. In such a fast playback mode, if stereoscopic images are instantly displayed, changes in the parallax amount become extremely rapid, so that it becomes less likely that the viewer stereoscopically perceives objects in the content data. In particular, if the content data is a movie, it becomes less likely that the viewer perceives motion of the objects in the content.

Patent Document 1 proposes technologies to display a video as two-dimensional images in the fast playback mode, in order to resolve such problems. According to the disclosed technologies in Patent Document 1, content data are played back as two-dimensional video images during the fast playback mode for facilitating to comprehend the movement of objects in the content data.

It may be other needs than the aforementioned playback of the content data at the standard or fast playback speed for the image playback devices such as DVD players and Blu-ray players to playback the content data under a quick view playback mode. In the quick view mode, which is suitable for the viewer to enjoy the actual content rather than for finding a point for viewing in the normal playback, the content data are generally played back at a faster speed than the standard playback speed but at a slower speed than the fast playback speed with audio associated with the images. The viewer may comprehend the details of the content in a shorter time under the quick view playback mode than the standard playback speed mode and listen to the audio included in the content data, which are not played back under the fast playback mode. For example, existing image playback devices have playback modes at 1.3 times and 1.5 times as high as the standard playback speed of the content data, as the quick view playback mode.

In the disclosed technologies in Patent Document 1, if a viewer wants to play back the content data under the quick view playback mode, the video images are two-dimensionally displayed, which results in insufficient presentation of the contents included in the content data to the viewer. Alternatively, if the content data are played back as stereoscopic video images without any modification, temporal variations in the parallax amount between left and right image frames which are displayed on the display become too large. Therefore it becomes likely that the large temporal variations cause strain on the viewer's eyes.
Patent Document 1: JP 2005-110121 A

### DISCLOSURE OF THE INVENTION

It is an object of the present invention to provide an image playback device and a display device which allow a viewer to comprehend details of contents in a relatively short period of time with little strain on the viewer's eyes while the viewer views stereoscopic objects in the content data.

An image playback device according to one aspect of the present invention comprises: a playback portion which plays back content data to make a video stereoscopically viewed by means of video data including a first image for a first view point and a second image for a second view point; a setting portion configured to set a playback speed for playing back the content data; and an adjuster configured to adjust parallax information about parallax between the first and second images in response to the playback speed set by the setting portion.

A display apparatus according to another aspect of the present invention comprises: a playback portion which plays back content data to make a video stereoscopically viewed by means of video data including a first image for a first view point and a second image for a second view point; a display portion configured to display the video data; a setting portion configured to set a playback speed for playing back the content data; and an adjuster configured to adjust parallax information about parallax between the first and second images in response to the playback speed set by the setting portion.

### BRIEF DESCRIPTION OF THE DRAWINGS

FIG. 1 is a schematic view of a video system with a television device comprising an image playback device according to the first embodiment.

FIG. 2 is a schematic view of a parallax amount between images captured from different view points.

FIG. 3 is a block diagram schematically showing a configuration of the image playback device shown in FIG. 1.

FIG. 4 is a block diagram schematically showing a configuration of the eyeglass device shown in FIG. 1.

FIG. 5 is a schematic view of the exemplary image playback device shown in FIG. 3.

FIG. 6 is a schematic view of the exemplary image playback device shown in FIG. 3.

FIG. 7 is a schematic view of the exemplary image playback device shown in FIG. 3.

FIG. 8 is a schematic view of the exemplary image playback device shown in FIG. 3.

FIG. 9 is a schematic view of the exemplary image playback device shown in FIG. 3.

FIG. 10 is a schematic view of the exemplary image playback device shown in FIG. 3.

FIG. 11 is a schematic view of the exemplary image playback device shown in FIG. 3.

FIGS. 12A-12C are schematic views of exemplary audio data adjustment by an audio signal processor in the image playback device shown in FIG. 3.

FIG. 13 is a flowchart schematically showing control of the image playback device shown in FIG. 3.

FIG. 14 is a block diagram schematically showing a configuration of an image playback device according to the second embodiment.

FIG. 15 is a schematic view of image data used in the image playback device according to the second embodiment.

FIG. 16 is a schematic view of exemplary image adjustment by an adjuster in the image playback device according to the second embodiment.

FIG. 17 is a schematic view of exemplary image adjustment by the adjuster in the image playback device according to the second embodiment.

### DETAILED DESCRIPTION OF THE INVENTION

### First Embodiment

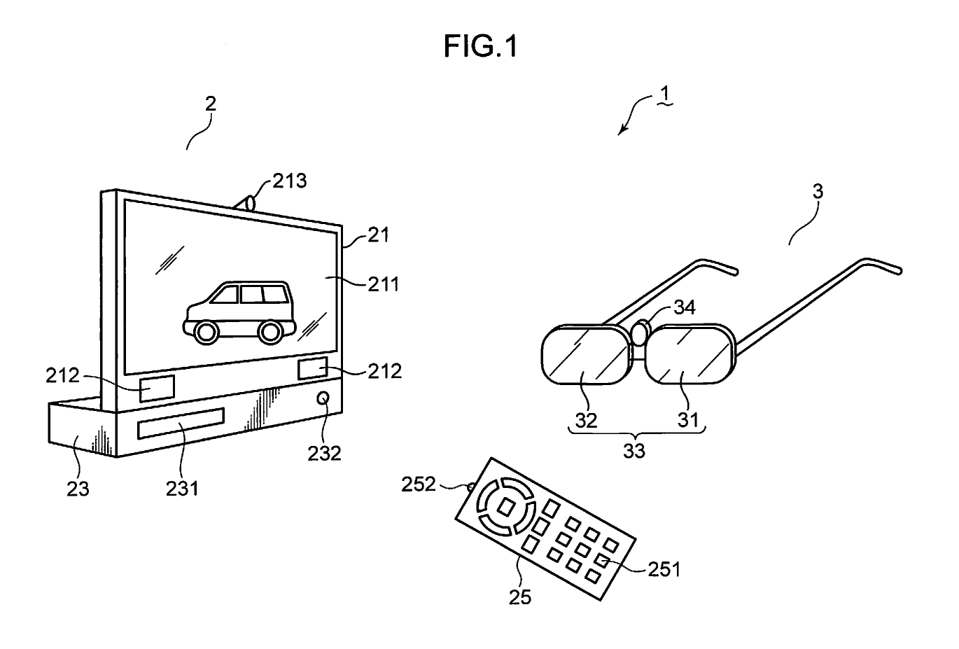

A video system according to the first embodiment is described with reference to the accompanying drawings. FIG. 1 shows a schematic view of the video system having a television device with an image playback device of the first embodiment. The video system shown in FIG. 1 is merely exemplary, and any other technologies which are suitable for viewing stereoscopic video images may be applied to video display methodologies or methods for assisting in viewing the video images.

The video system 1 has a television device 2 exemplified as the display device, and an eyeglass device 3 for assisting in viewing video images displayed by the television device 2. The television device 2 comprises a display device 21 which displays video images, an image playback device 23 which outputs a stereoscopic video signal to the display device 21, and a remote controller 25 which is used for operating the image playback device 23 and/or the display device 21. The remote controller 25 includes several buttons 251 which are used for inputting desired instructions to the image playback device 23 and/or the display device 21, and a transmitter 252 which transmits instructions that are input by the viewer as control signals to the image playback device 23 and/or the display device 21. For example, the control signal may be sent as an infrared signal or an RF signal, or may be sent by other methodologies to transmit an instruction desired by the viewer to the image playback device 23 and/or the display device 21. In the present embodiment, the viewer may operate the remote controller 25 to control a playback speed of the image playback device 23.

The image playback device 23 comprises a storage portion 231 which stores a storage medium such as a DVD disk or Blu-ray disk (not shown in FIG. 1) and a receiver 232 which receives the control signal from the remote controller 25. Content data presented to (viewed by) the viewer are contained in the storage medium. The content data include video data and/or audio data. As described below, the image playback device 23 plays back the content data in response to the control signal from the remote controller 25 to output a stereoscopic video signal and an audio signal to the display device 21. The video data includes a left image obtained by capturing an image of an object in the view field of the left eye and a right image obtained by capturing an image of an object in the view field of the right eye. In the present embodiment, the viewer's left eye is exemplified as the first view point. The viewer's right eye is exemplified as the second view point. Alternatively, the viewer's right eye may be the first view point while the viewer's left eye may be the second view point. In the present embodiment, an image viewed by the left eye is exemplified as the first image. An image viewed by the right eye is exemplified as the second image. Alternatively, the image viewed by the right eye may be the first image while the image viewed by the left eye may be the second image. In the present embodiment, if the left image is viewed by the left eye while the right image is viewed by the right eye, an object displayed in the left and right images is stereoscopically perceived by the viewer.

The display device 21 comprises a display panel 211 which is used as the display portion for displaying a stereoscopic video signal as the stereoscopic video image, a speaker 212 which is used as an audio output portion to output an audio signal as sound, and a transmitter 213 which outputs a synchronization signal to synchronize operations of the eyeglass device 3 with the video frames displayed on the display panel 211. For example, the display panel 211 alternately displays the right and left image frames. The speaker 212 outputs sound corresponding to the video displayed on the display panel 211. For example, the transmitter 213 outputs a synchronization signal in synchronism with the switching operation between the left and right image frames. A device which employs a plasma display panel, a liquid crystal panel or a CRT, a device using organic electroluminescence or another device which allows a viewer to view video images in response to the stereoscopic video signal may be used as the display panel 211. The synchronization signal may be sent as an infrared beam or an RF signal or by any other methodologies to transmit the synchronization signal to the eyeglass device 3.

The eyeglass device 3 looks like eyeglasses for correcting eyesight. The eyeglass device 3 comprises an optical filter portion 33 including a left filter 31 which is situated in front of the viewer's left eye and a right filter 32 which is situated in front of the viewer's right eye if the viewer wears the eyeglass device 3, and a receiver 34 which is situated between the left and right filters 31, 32. The left and right filters 31, 32 may optically adjust light amounts transmitted to the left and right eyes. For example, the left and right filters 31, 32 may shut off optical paths of the light transmission to the left and right eyes, respectively, or may deflect the light transmitted to the left or right eye, in order to adjust the light amount. Liquid crystal elements may be used for such a kind of the left and right filters 31, 32.

The receiver 34 receives the synchronization signal transmitted by the display device 21. The eyeglass device 3 controls the optical filter portion 33 in response to the synchronization signal. As a result of the control in response to the synchronization signal, the light from the image frame is transmitted to the viewer's left eye via the left filter 31 during the display of the left image frame on the display panel 211 whereas the light amount reaching the viewer's right eye is decreased by the right filter 32. The light from the image frame is transmitted to the viewer's right eye via the right filter 32 during the display of the right image frame on the display panel 211 whereas the left filter 31 decreases the light amount reaching the viewer's left eye. Thus, the viewer views the left and right image frames with the left and right eyes, respectively, so that objects in the left and right images of the video data are stereoscopically (three-dimensionally) perceived by the viewer. The object is stereoscopically perceived or viewed by the viewer to be popping up toward the viewer from the display panel or to be deepened into the display panel.

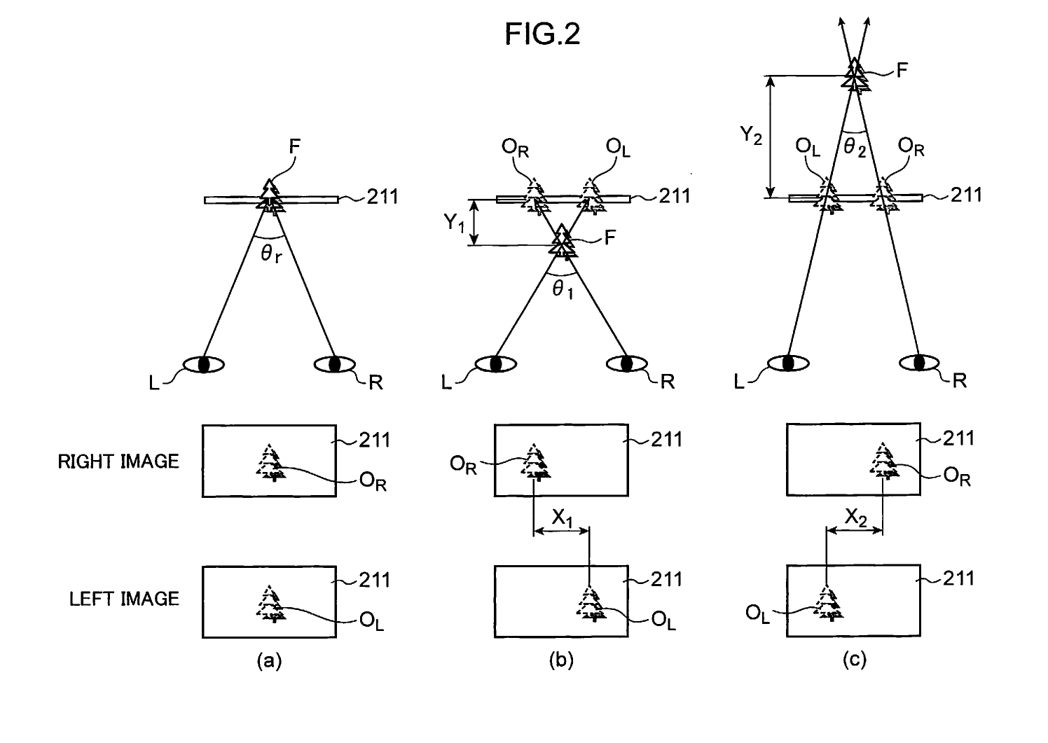

FIG. 2 exemplarily shows a stereoscopic image. A relationship between the parallax amount of the left and right images in the video data of the contact data and the video image stereoscopically perceived by the viewer is described with reference to FIGS. 1 and 2. The section (a) of FIG. 2 shows the left and right images while the parallax amount between the left and right images is “0”, and the corresponding video image viewed and/or perceived by the viewer. The section (b) of FIG. 2 shows the left and right images while the parallax amount between the left and right images is a “positive value”, and the corresponding video image viewed and/or perceived by the viewer. The section (c) of FIG. 2 shows the left and right images while the parallax amount between the left and right images is a “negative value”, and the corresponding video image viewed and/or perceived by the viewer. The aforementioned definition of the “positive” and “negative” parallax amount is given for the purpose of clarifying the descriptions, and does not limit the principles of the present embodiment in any way. Therefore, the relationship between the left and right images shown in the section (b) of FIG. 2 may be defined as a “negative value” whereas the relationship between the right and left images shown in the section (c) of FIG. 2 may be defined as a “positive value”.

The upper drawings in the sections (a) to (c) of FIG. 2 show positions of an object on the display panel 211 and positions of the object as perceived by the viewer with respect to the display panel 211. The middle drawings in FIG. 2 show the right image displayed on the display panel 211. The lower drawings in FIG. 2 show the left image displayed on the display panel 211.

In the left and right images shown in the sections (a) to (c) of FIG. 2, a tree is depicted as the object. The term “object” used in the descriptions of the present embodiment means an image of a physical object in a video image which is perceived by the viewer. The object displayed in the left image is labeled with the reference symbol O_{L} and the object displayed in the right image is labeled with the reference symbol O_{R}. The reference symbol R shown in the sections (a) to (c) of FIG. 2 indicates the viewer's right eye whereas the reference symbol L indicates the viewer's left eye. The reference symbol F shown in FIG. 2 indicates the object which is stereoscopically perceived by the viewer.

As shown in the section (a) of FIG. 2, if the objects O_{L}, O_{R} in the left and right images are displayed at the position on the display panel 211 (i.e., the parallax amount is “0”), the object F is perceived by the viewer to be on the display panel 211.

If the object O_{L} in the left image is positioned in the right region of the display panel 211 whereas the object O_{R} in the right image is positioned in the left region of the display panel 211 as shown in the section (b) of FIG. 2 and if the parallax between the positions of these objects O_{L}, O_{R} is “X₁” (where X₁ is a positive value), the convergence point between the left and right eyes L, R (the intersection point between the sight lines from the left eye L to the object O_{L} and from the right eye R to the object O_{R}) becomes closer to the viewer than the display panel 211. The object F is perceived by the viewer as if situated at the convergence point which is closer to the viewer than the display panel 211. The distance Y₁ between the object F and the display panel 211 shown in the section (b) of FIG. 2 is exemplified as a volume of how large the object F pops up (pop-up volume).

If the object O_{L} in the left image is positioned in the left region of the display panel 211 whereas the object O_{R} in the right image is positioned in the right region of the display panel 211 and if the parallax between the positions of these objects O_{L}, O_{R} is “X₂” (where X₂ is a negative value) as shown in the section (c) of FIG. 2, the convergence point between the left and right eyes L, R is further from the viewer than the display panel 211. The object F is perceived by the viewer as if situated at a convergence point which is further from the viewer than the display panel 211. The distance Y₂ between the object F and the display panel 211 shown in the section (c) of FIG. 2 is exemplified as a volume of how large the object F deepens in (deep-in volume).

As shown in the sections (a) to (c) of FIG. 2, a distance from the display panel 211 to the object F increases as the absolute value of the difference between the positions of the objects O_{L}, O_{R} becomes greater. On the other hand, the distance from the display panel 211 to the object F (the pop-up or deep-in volume Y₁, Y₂) decreases as the absolute value of the difference between the positions of the objects O_{L}, O_{R} becomes smaller.

In the present embodiment, the differences X₁, X₂ between the positions of the objects O_{L}, O_{R} (i.e., the parallax amount) are exemplified as the parallax information about parallax. Alternatively, the parallax information may be other parameters to increase or decrease the distance from the display panel 211 or the display surface, which displays the objects O_{L}, O_{R}, to the object F as perceived by the viewer. The term “increase the parallax amount” used in the present embodiment means increasing the difference in the positions of the objects O_{L}, O_{R} to cause a longer distance from the display surface to the object F (the pop-up or deep-in volume Y₁, Y₂). Alternatively, a parameter (parallax information) other than the parallax amount may be adjusted in order to increase the distance from the display surface to the object F (the pop-up or deep-in volume Y₁, Y₂). The term “decrease the parallax amount” which is used in the present embodiment means decreasing the difference in the positions of the objects O_{L}, O_{R} to cause a shorter distance from the display surface to the object F (the pop-up or deep-in volume Y₁, Y₂). Alternatively, a parameter (parallax information) other than the parallax amount may be adjusted in order to decrease the distance from the display surface to the object F (the pop-up or deep-in volume Y₁, Y₂). For example, it may be exemplified as adjustment of parameters other than the parallax amount to apply a shadow to an object by processing the video signal, change brightness of the object itself or change colors of the object. Such various methodologies may contribute to the adjustment of the distance perspective of the viewer.

It is empirically known that an increase in the distance from the display panel 211 to the object F increases strain on the viewer's eyes. It is empirically known that an increase in positional change speed of the object F increases the strain on the viewer's eyes if the left and right image frames are displayed on the display panel 211 so as to change a position of the object F from the position of the object F shown in the section (b) of FIG. 2 to the position of the object F shown in the section (c) of FIG. 2.

In the present embodiment, for example, the display device 21 displays the left and right image frames at a frame rate of 120 Hz (a total of 120 frames (which include the left and right image frames) per second are displayed). The standard playback speed is set to a playback speed at which the frames of the image signal on the recording medium may be output and displayed without skipping or holding. In the present embodiment, the standard playback speed is exemplified as the first speed. The playback of content data at the standard playback speed by the image playback device 23 is exemplified as the first mode.

In the present embodiment, the quick view playback speed is set to a playback speed, which is 1.3 times as high as the standard playback speed. Alternatively, the quick view playback speed may be set to another playback speed which is faster than the standard playback speed so as to allow the viewer to comprehend the details of the content data. In the present embodiment, one playback frame is skipped out of 1.3 frames in the quick view playback mode. If the frames in the medium are played back at a speed which is 1.3 times as high as the standard speed (120 frames per second), 156 playback frames per second are played back. In the quick view playback mode, one frame is skipped out of 1.3 frames, so that the display time of each playback frame is substantially as long as that of the standard playback. Thus, the output to the display device 21 becomes 120 frames per second. In the present embodiment, the quick view playback speed is exemplified as the second speed. The playback of the content data at the quick view playback speed by the image playback device 23 is exemplified as the second mode.

In the present embodiment, the fast playback speed is defined as a playback speed which is 2 times as high as the standard playback speed. Alternatively, the fast playback speed may be set as another playback speed which is faster than the quick view playback speed. In the present embodiment, in the fast playback mode, one playback frame is skipped out of 2 frames. Thus, the output to the display device 21 becomes 120 frames per second. The playback of the content data at the fast playback speed by the image playback device 23 is exemplified as the third mode.

In the present embodiment, an increase from the standard playback speed to the quick view playback speed or the fast playback speed is achieved by skipping the playback frames. Alternatively, the increase from the standard playback speed to the quick view playback speed or the fast playback speed may be achieved by shortening the display time of every playback frame.

As described with reference to FIG. 2, while the viewer views the stereoscopic video at the quick view playback speed which is faster than the standard playback speed, the position of the object F perceived by the viewer changes more rapidly than when the viewer views the stereoscopic video at the standard playback speed, which results in increased strain on the viewer's eyes.

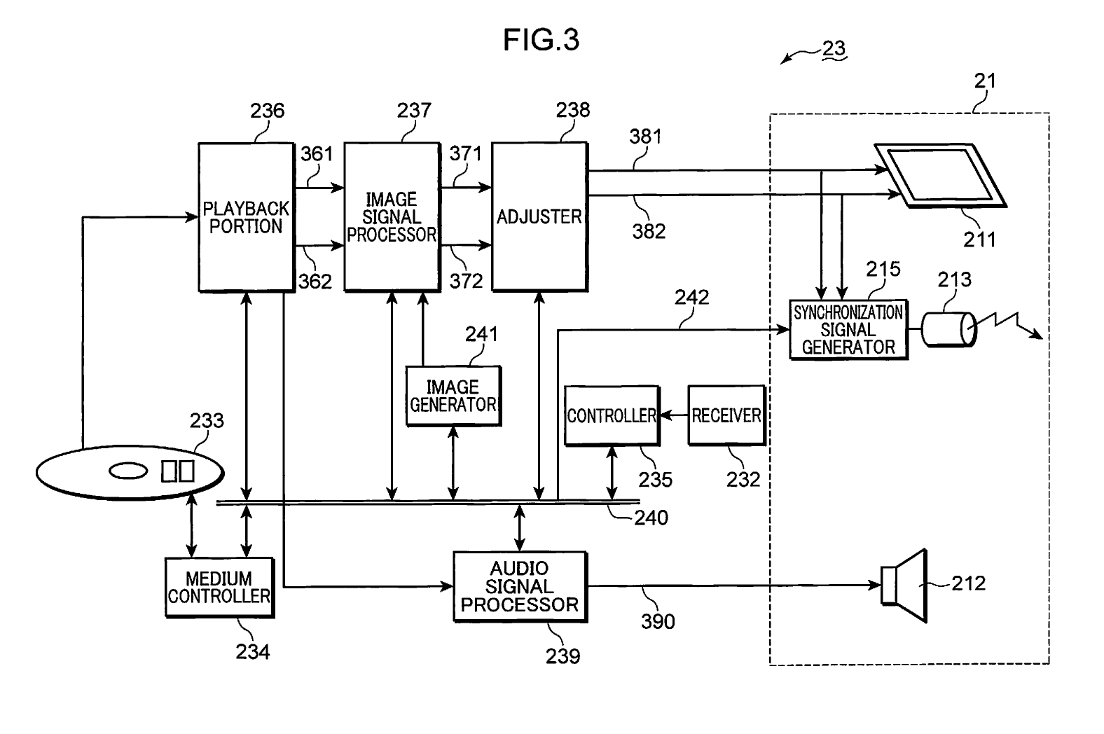

FIG. 3 is a schematic block diagram showing a configuration of the display device 21 and the image playback device 23 depicted in FIG. 1. The image playback device 23 is described with reference to FIGS. 1 to 3.

The storage portion 231 of the image playback device 23 stores the storage medium 233 in which content data such as video images and music videos are contained (e.g., a Blu-ray disk or a DVD disk). The image playback device 23 includes a medium controller 234 configured to control the recording medium 233. The medium controller 234 controls the drive device (not shown), which drives the storage medium 233, or the playback protocol such as the playback address setup procedures.

The receiver 232 receives the control signal from the remote controller 25 as described with reference to FIG. 1. The image playback device 23 includes a controller 235. The controller 235 implements overall control of the image playback device 23. The receiver 232 outputs a control signal containing operation information, which is input by the viewer, to the controller 235.

The image playback device 23 includes the playback portion 236 which plays back the content data contained in the storage medium 233, an image signal processor 237 which processes the image signals generated in response to the video data included in the content data; an adjuster 238 which adjusts the parallax amount between the left and right images (e.g., the parallax amount X₁, X₂ described with reference to FIG. 2), in response to the image signal processed by the image signal processor 237; an audio signal processor 239 which processes an audio signal generated in response to the audio data included in the content data; and a bus 240 for transmitting the control signal output from the controller 235 to the medium controller 234, the playback portion 236, the image signal processor 237, the adjuster 238 and the audio signal processor 239. The controller 235 sends the control signals to control the medium controller 234, the playback portion 236, the image signal processor 237, the adjuster 238 and the audio signal processor 239 via the bus 240, respectively, in response to the control signals from the receiver 232 in order to control them. As a result, the image playback device 23 executes the image playback processes.

The controller 235 may control the medium controller 234 and the playback portion 236 to switch the playback speed of the content data contained in the storage medium 233 to the standard playback speed, the quick view playback speed, which is faster than the standard playback speed, and the fast playback speed, which is faster than the quick view playback speed, in response to operations of the remote controller 25. In the present embodiment, the controller 235 is exemplified as the setting portion which sets the playback speed to play back the content data. The controller 235 selectively sets a playback mode at standard playback speed, the quick view playback speed or the fast playback speed, in response to operations of the remote controller 25 by the viewer.

In the present embodiment, the adjuster 238 adjusts the parallax amount between the left and right images in response to the playback speed controlled by the controller 235 (the standard playback speed, the quick view playback speed or the fast playback speed). Alternatively, the adjuster 238 may adjust another parameter (parallax information) for adjusting the pop-up or deep-in volume of the object F which is perceived by the viewer, in response to the playback speed (standard playback speed, quick view playback speed, fast playback speed).

The image playback device 23 may include an image generator 241 configured to generate a menu image so that the viewer may list the content data contained in the storage medium 233. The image generator 241 receives the control signal from the controller 235 via the bus 240. The image generator 241 then generates the menu image in response to the control signal.

The playback portion 236 reads out image data, which are subjected to the playback, from the video data of the content data, which are contained in the storage medium 233. The playback portion 236 then outputs image data 361 corresponding to the left image and image data 362 corresponding to the right image from the read image data to the image signal processor 237. The playback portion 236 also reads out audio data, which are subjected to the playback, from the content data contained in the storage medium 233. The playback portion 236 then outputs the audio data to the audio signal processor 239. The playback portion 236 also reads out auxiliary data about the image data, which are subjected to the playback, from the content data contained in the storage medium 233. The playback portion 236 then outputs the auxiliary data to the controller 235 via the bus 240.

Optionally, the image signal processor 237 may execute expansion processes on compressive-encoding such as MPEG-2 or H.264, which is carried out during recording, and display quality adjustment processes to the image data 361, 362 corresponding to the left and right images output from the generator 236. The image data 371, 372 corresponding to the left and right images after these processes are output to the adjuster 238.

The menu image generated by the image generator 241 may be output to the image signal processor 237. The image signal processor 237 may directly output the menu image to the adjuster 238. Alternatively, the image signal processor 237 may superimpose a menu image on image data 371, 372 corresponding to the left and right images to output the data to the adjuster 238.

The adjuster 238 adjusts the parallax amount between the image data 371, 372 corresponding to the left and right images, which are output from the image signal processor 237 under the control of the controller 235. The image data 381, 382 corresponding to the left and right images after the adjustment of the parallax amount between them are output to the display panel 211 of the display device 21.

Optionally, the audio signal processor 239 performs audio signal processes such as equalizer processes on the audio data output from the processor 236. The audio signal processor 239 then outputs the audio signal 390 after the audio signal processes to the speaker 212 of the display device 21.

The display device 21 has a synchronization signal generator 215 used for synchronization control between the television device 2 and the eyeglass device 3. The synchronization signal generator 215 generates a synchronization signal for the eyeglass device 3 in response to the image signal output from the image playback device 23 to the display device 21, and then outputs the synchronization signal to the transmitter 213. The transmitter 213 outputs the synchronization signal, which is generated by the synchronization signal generator 215, to the receiver 34 of the eyeglass device 3.

The controller 235 of the image playback device 23 may output a mode control signal 242 to the synchronization signal generator 215. The mode control signal 242 may be omitted as appropriate, depending on the eyeglasses control method during a fast playback mode which is described hereinafter. For example, the mode control signal 242 may be output in response to machine control on the basis of HDMI CEC standards.

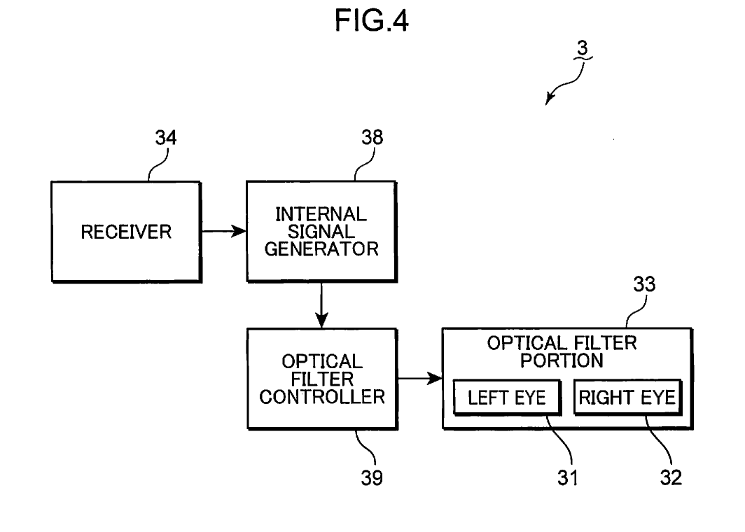

FIG. 4 is a block diagram showing a configuration of the eyeglass device 3 shown in FIG. 1. The eyeglass apparatus 3 is described with reference to FIGS. 1 to 4.

The eyeglass device 3 has the receiver 34, an internal signal generator 38, an optical filter controller 39 and the optical filter portion 33. The receiver 34 receives the synchronization signal sent from the transmitter 213 of the display device 21, converts the signal to an electrical timing-control signal, and outputs the converted signal to the internal signal generator 38.

The internal signal generator 38 generates an internal signal to control internal parts of the eyeglass device 3, respectively, in response to the timing control signal. The optical filter controller 39 controls operations of the left and right filters 31, 32 of the optical filter portion 33, in response to the internal signal which is generated by the internal signal generator 38. Accordingly, the left filter 31 permits light transmission to the viewer's left eye whereas the right filter 32 decreases a light amount transmitted to the viewer's right eye while the display panel 211 displays a video signal of the image data 381 corresponding to the left image. On the other hand, the right filter 32 permits light transmission to the viewer's right eye whereas the left filter 31 decreases a light amount transmitted to the viewer's right eye while the display panel 211 displays a video signal of the image data 382 corresponding to the right image. Consequently, the viewer may stereoscopically view the displayed objects O_{R}, O_{L} in the image data 381, 382 (as an object F), as described with reference to FIG. 2.

Operations of the image playback device 23 during quick view playback are further described with reference to FIGS. 1 and 3.

If the viewer operates the remote controller 25 to instruct playback of the content data at the quick view playback speed, the controller 235 controls the playback portion 236, the image signal processor 237, the adjuster 238, the medium controller 234, the image generator 241 and the audio signal processor 239 via the bus 240 to play back the content data (image data and audio data) from the storage medium 233 at the quick view playback speed (e.g., a playback speed which is 1.3 times as high as the standard playback speed). The image signal playback portion 237 reduces images in the video data to output image data 371, 372 to the adjuster 238. Accordingly, temporal changes in the parallax amount become greater. The adjuster 238 executes processes for adjusting the parallax amount, so as to reduce the temporal changes in the parallax amount.

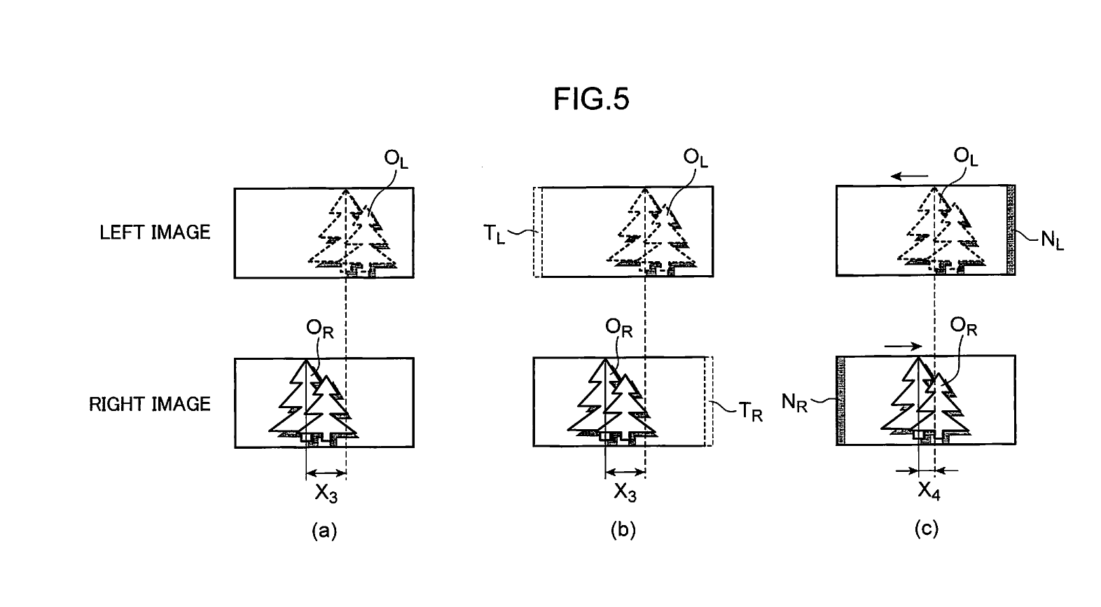

The sections (a) to (c) of FIG. 5 show the processes for adjusting the parallax amount by the adjuster 238. The section (a) of FIG. 5 shows the left images of the content data (video data) contained in the storage medium 233. The section (b) of FIG. 5 shows processes for determining a shift amount by the adjuster 238. The section (c) of FIG. 5 shows the left and right images after the parallax amount adjustment by the adjuster 238. The upper drawings of the sections (a) to (c) of FIG. 5 show the left image. The lower drawings of the sections (a) to (c) of FIG. 5 show the right image. The adjustment process for the parallax amount by the adjuster 238 is described with reference to FIGS. 1 to 3 and FIG. 5.

The parallax amount between the left and right images of the content data contained in the storage medium 233 is shown by the reference symbol “X₃” in the section (a) of FIG. 5. If the viewer operates the remote controller 25 to select the standard playback speed, the adjuster 238 outputs the video signal (image data 381, 382) to the display device 21 with maintaining the parallax amount. If the viewer operates the remote controller 25 to select the quick view playback speed, the adjuster 238 defines a trim region T_{L} of a prescribed width from the left edge of the left image and a trim region T_{R} of a prescribed width from the right edge of the right image, as shown in the section (b) of FIG. 5. The adjuster 238 then horizontally moves the region of the left image other than the trim region T_{L} by an amount corresponding to the width of the trim region T_{L}. Thus, the image data of the trim region T_{L} is erased, so that a region N_{L} is created in which image data of the same width as the width of the trim region T_{L} is absent along the right edge of the left image. For example, supplementary image data, which are displayed in gray, may be embedded in the region N_{L} where the image data is absent. Likewise, the adjuster 238 horizontally moves the region of the right image other than the trim region T_{R} by an amount corresponding to the width of the trim region T_{R}. Thus, the image data of the trim region T_{R} is erased, so that a region N_{R} is created in which image data of the same width as the width of the trim region T_{R} is absent along the left edge of the right image. For example, supplementary image data, which are displayed in gray, may be embedded in the region N_{R} where the image data is absent. The left and right images are shifted so that the objects O_{L}, O_{R} displayed in the left and right images, respectively, become close to each other. Accordingly, the parallax amount between the left and right images (the positional difference between the objects O_{L}, O_{R} in the left and right images) is reduced. The reduced parallax amount is indicated by the reference symbol “X₄” in the section (c) of FIG. 5. Therefore, the adjuster 238 may reduce the parallax amount if the content data are played back at the quick view playback speed, in comparison to the parallax amount under the playback of content data at the standard playback speed.

If the image playback device 23 is designed to have a few playback speeds as the quick view playback speed, preferably, the trim regions T_{L}, T_{R} become larger as the playback speed increases. Thus, the parallax amount is adjusted to be smaller at a relatively fast quick view playback speed whereas the parallax amount is adjusted to be greater at a relatively slow playback speed. The widths of the trim regions T_{L}, T_{R} may be calculated and defined by means of a prescribed calculation formula which uses the playback speed as a parameter. Alternatively, a look-up table may be prepared for indicating the widths of the trim regions T_{L}, T_{R} corresponding to the quick view playback speeds, respectively. The adjuster 238 may select the trim regions T_{L}, T_{R} corresponding to a particular quick view playback speed, which is defined by viewer's operations of the remote controller 25, from the trim regions T_{L}, T_{R} prepared in the look-up table.

Preferably, the trim region T_{L} corresponding to the left image has the same width as the trim region T_{R} corresponding to the left image, which results in few differences between the positions of the object as stereoscopically perceived by a viewer during the playback at the standard playback speed and the quick view playback speed. The image shift process described with reference to FIG. 5 may be applied to only one of the left and right images as appropriate. Alternatively, the image shift process described with reference to FIG. 5 may be applied to the left and right images by means of mutually different shift amounts as appropriate.

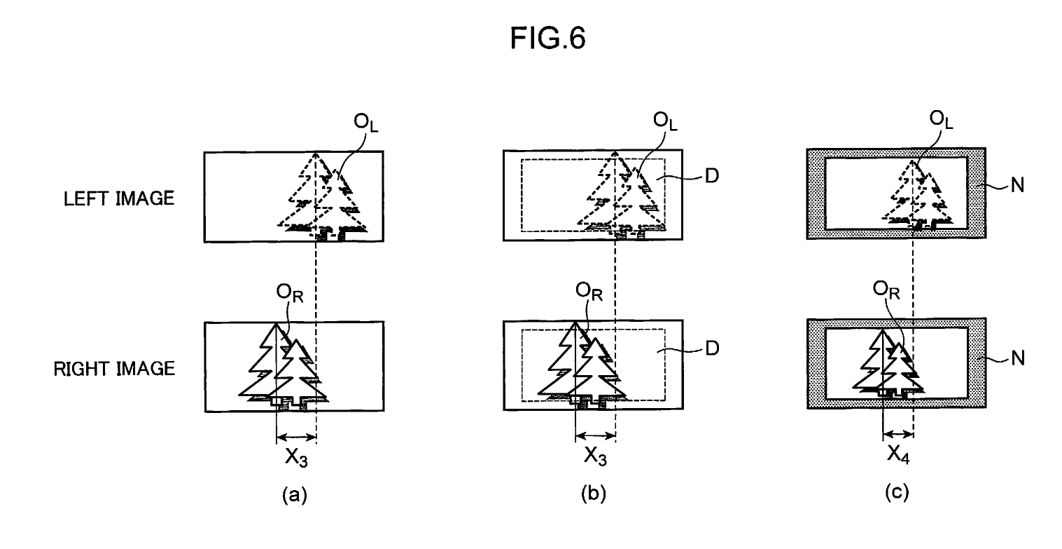

FIG. 6 shows another adjustment process for the parallax amount by the adjuster 238. The section (a) of FIG. 6 shows the left and right images of the content data (video data) stored in the storage medium 233. The section (b) of FIG. 6 shows processes for determining a contraction amount by the adjuster 238. The section (c) of FIG. 6 shows the left and right images after the adjustment of the parallax amount by the adjuster 238. The upper drawings of the sections (a) to (c) in FIG. 6 show the left images. The lower drawings of the sections (a) to (c) in FIG. 6 show the right images. The adjustment process for the parallax amount by the adjuster 238 is described with reference to FIGS. 1 to 3 and the sections (a) to (c) of FIG. 6.

The parallax amount between the left and right images of the content data contained in the storage medium 233 is shown by the reference symbol “X₃” in the section (a) of FIG. 6. If the viewer operates the remote controller 25 to select the standard playback speed, the adjuster 238 outputs the video signal (image data 381, 382) to the display device 21 with maintaining the parallax amount. If the viewer operates the remote controller 25 to select the quick view playback speed, the adjuster 238 defines a display region D of a contracted image as shown in the section (b) of FIG. 6. The display region D has similar shape to the display region of the left and right images included in the content data. The position of the display region D is defined so that the center of the display region D coincides with the display region of the left and right images included in the content data. The adjuster 238 then lessens the left and right images to a region of the size defined by the display region D. Therefore, a region N without image data is produced at the edges of the contracted left and right images. For example, complementary image data may be embedded in the no image data region N, which may be displayed in gray. Due to the contraction process by the adjuster 238, the objects O_{L}, O_{R} displayed in the left and right images become closer to each other. Accordingly, the parallax amount between the left and right images (the positional difference between the objects O_{L}, O_{R} in the left and right images) is decreased. The decreased parallax amount is indicated by the reference symbol “X₄” in the section (c) of FIG. 6. Therefore, the adjuster 238 may decrease the parallax amount under the playback of the content data at the quick view playback speed in comparison to the parallax amount under the playback of the content data at the standard playback speed.

If the image playback device 23 is designed to have a few playback speeds as the quick view playback speed, preferably, the image contraction rate by the adjuster 238 becomes greater as the playback speed becomes faster. Accordingly, the parallax amount is adjusted to be smaller at a relatively fast quick view playback speed. The parallax amount is adjusted to be greater at a relatively slow playback speed. The image contraction rate by the adjuster 238 may be calculated and defined by means of a prescribed calculation formula which uses the playback speed as a parameter. Alternatively, a look-up table may be prepared for indicating image contraction rates corresponding to the quick view playback speeds, respectively. The adjuster 238 may select the image contraction rate corresponding to a particular quick view playback speed, which is defined by viewer's operations of the remote controller 25, from the image contraction rates prepared in the look-up table.

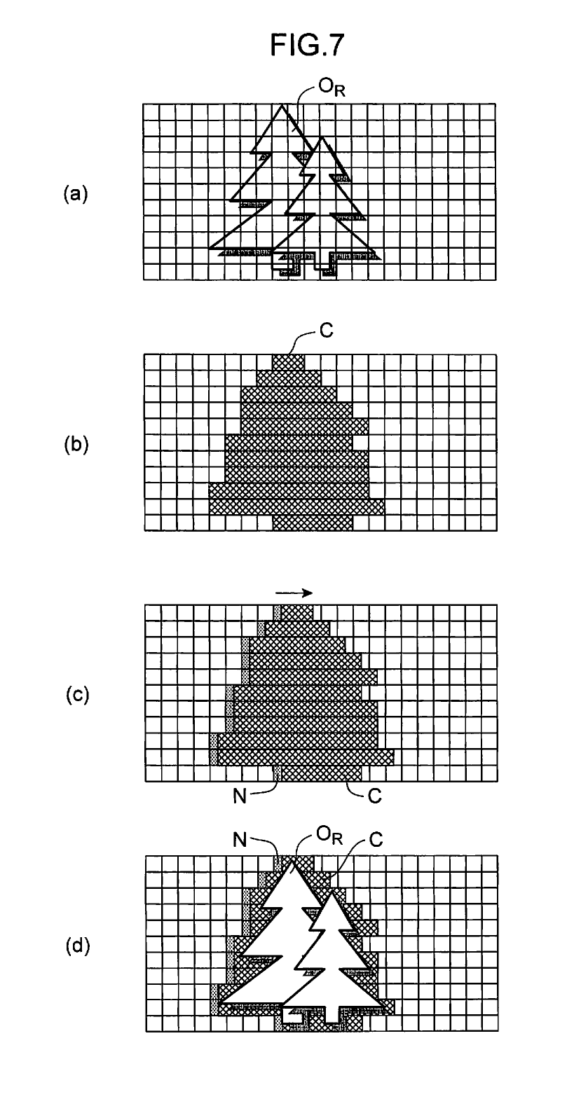

FIG. 7 shows yet another adjustment process for the parallax amount by the adjuster 238. The sections (a) to (d) of FIG. 7 show the processes sequentially carried out by the adjuster 238. The images shown in the sections (a) to (d) of FIG. 7 are the right images. The processes by the adjuster 238 described with reference to the sections (a) to (d) of FIG. 7 may be similarly applied to the left image. The adjustment process for the parallax amount by the adjuster 238 is described with reference to FIGS. 1 to 3, and the section (a) of FIG. 5 to the section (d) of FIG. 7.

In the processes shown in the sections (a) to (c) of FIGS. 5 and 6, the adjuster 238 processes the entire image. On the other hand, in the processes shown in the sections (a) to (d) of FIG. 7, the adjuster 238 executes the processes object by object in the image. Therefore, the adjuster 238, preferably, has a segmentation portion which divides the first and second images into segments, an image segment identification portion which identifies image segments that contributes to display of the object out of the image segments obtained by the segmentation, and a changing portion which changes the display position of the image data included in the image segment identified by the identification portion. If the viewer operates the remote controller 25 to select the quick view playback speed, the segmentation portion divides the image into several square image segments as shown in the section (a) of FIG. 7. The image segment identification portion identifies image segments which contribute to the display of the object O_{R} in the image. Existing image processing technologies such as outline extraction may be employed for the identification of the object O_{R}. As shown in the section (b) of FIG. 7, the image segment identification portion determines whether or not each image segment contributes to the display of the object O_{R}, and specifies a region C which contributes to the display of the object O_{R}. As shown in the section (c) of FIG. 7, the changing portion then moves rightward the display position of the image data, which are included in the region C. The movement amount of the display position of the image data contained in the region C is appropriately determined in response to the magnitude of the quick view playback speed. Due to the change in the display position of the image data contained in the region C, a region N without image data happens to the left of the region C. Complementary image data are embedded in the regions N generated in each image segment by means of image data of the peripheral image segments. For example, if it is assumed that a continuation of the left background image becomes visible after the movement of the object O_{R} to the right, the image data of the adjacent left region may be copied. Therefore, the object O_{R} is moved by a prescribed amount in the image during the playback of the content data in the quick view playback speed, as shown in the section (d) of FIG. 7, which results in a decreased parallax amount between the left and right images. Therefore, the adjuster 238 may reduce the parallax amount if the content data are played back at the quick view playback speed, in comparison to the parallax amount under the playback of the content data at the standard playback speed.

The movement of the object in the image is further described with reference to the sections (a) to (c) of FIG. 2, FIG. 3 and the sections (a) to (d) of FIG. 7.

The changing portion may calculate a reference convergence angle θᵣ between the left and right eyes L, R which view the object F on the display panel 211, in response to the positional difference X₁ or X₂ between the objects O_{L}, O_{R} in the left and right images included in the content data. The changing portion may calculate the convergence angle θ₁ or θ₂ between the left and right eyes L, R under X₁ or X₂ of the positional difference between the objects O_{L}, O_{R}, in response to the values X₁ or X₂ of the positional difference between the objects O_{L}, O_{R}. The changing portion may move the objects O_{L}, O_{R} by the methodologies described with reference to the sections (a) to (d) of FIG. 7, so that a difference between the reference convergence angle θᵣ and the absolute value of the convergence angle θ₁ or θ₂ under X₁ or X₂ of the positional difference between the objects O_{L}, O_{R} becomes smaller during the playback at the quick view playback speed than the standard playback speed.

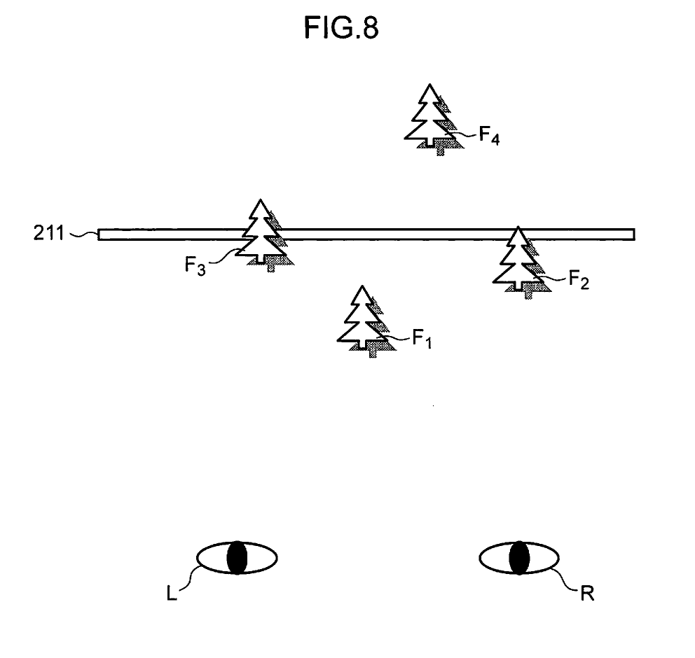

FIG. 8 shows movements of objects where several objects which are stereoscopically perceived. The movements of the objects are described with reference to the sections (a) to (c) of FIG. 2, FIG. 3, the sections (a) to (d) of FIG. 7 and FIG. 8.

The adjuster 238 may select particular objects from several objects displayed in the first and second images to process the selected image as described with reference to the sections (a) to (d) of FIG. 7. Therefore, the adjuster 238 preferably has an object identification portion which identifies the particular objects. As shown in FIG. 8, if there are the objects F₁ to F₄ which are stereoscopically perceived by the viewer, the object identification portion may identify a first object which is perceived to be situated at the closest position to the viewer and a second object which is perceived to be situated at the furthest position from the viewer, in response to the positional difference X₁ or X₂ between the objects O_{L}, O_{R} in the left and right images. In FIG. 8, the reference numeral F₁ is assigned to the object identified as the first object while the reference numeral F₄ is assigned to the object identified as the second object. The changing portion may handle the object F₁, which is perceived to be situated in the closest position to the viewer, and the object F₄, which is perceived to be situated in the furthest position from the viewer, as objects to be moved. The changing portion may then move these objects in the image by means of the techniques described with reference to the sections (a) to (c) of FIG. 2 and the sections (a) to (d) of FIG. 7. Due to the decreased pop-up and/or deep-in volumes of the objects viewed by the viewer from the display panel 211, there may be little strain on the viewer's eyes.

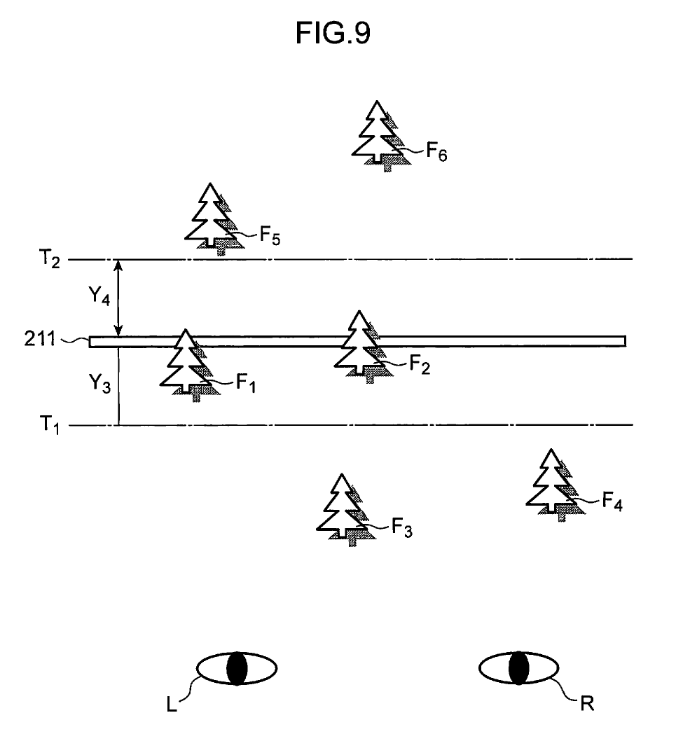

FIG. 9 shows another method for moving objects where several objects are stereoscopically perceived. The other method for moving the objects is described with reference to the sections (a) to (c) of FIG. 2, FIG. 3, the sections (a) to (d) of FIG. 7 and FIG. 9.

The object identification portion may select an object to move on the basis of a threshold value which is defined for the distance from the display panel 211 to the object perceived by the viewer. FIG. 9 shows a line representing the threshold value T₁ on the pop-up side so that the line is distant by Y₃ from the display panel 211 towards the viewer. FIG. 9 also shows another line representing the threshold value T₂ on the deep-in side so that the line is more distant by Y₄ from the viewer than the display panel 211.

FIG. 9 shows objects F₁, F₂ which are perceived in the region between the lines representing threshold values T₁, T₂. FIG. 9 also shows objects F₃, F₄ which are closer to the viewer than the line representing the threshold value T₁. FIG. 9 also shows objects F₅, F₆ which are more distant from the viewer than the line representing the threshold value T₂.

The object identification portion selects the objects F₃, F₄ which are closer to the viewer than the line representing the threshold value T₁ and the objects F₅, F₆, which are more distant from the viewer than the line representing the threshold value T₂, to move them. The changing portion changes the display positions of the selected objects F₃, F₄, F₅, F₆ by means of the methodologies described with reference to the sections (a) to (c) of FIG. 2 and the sections (a) to (d) of FIG. 7. Due to the decreased pop-up and/or deep-in volumes of the objects viewed by the viewer from the display panel 211, there may be little strain on the viewer's eyes.

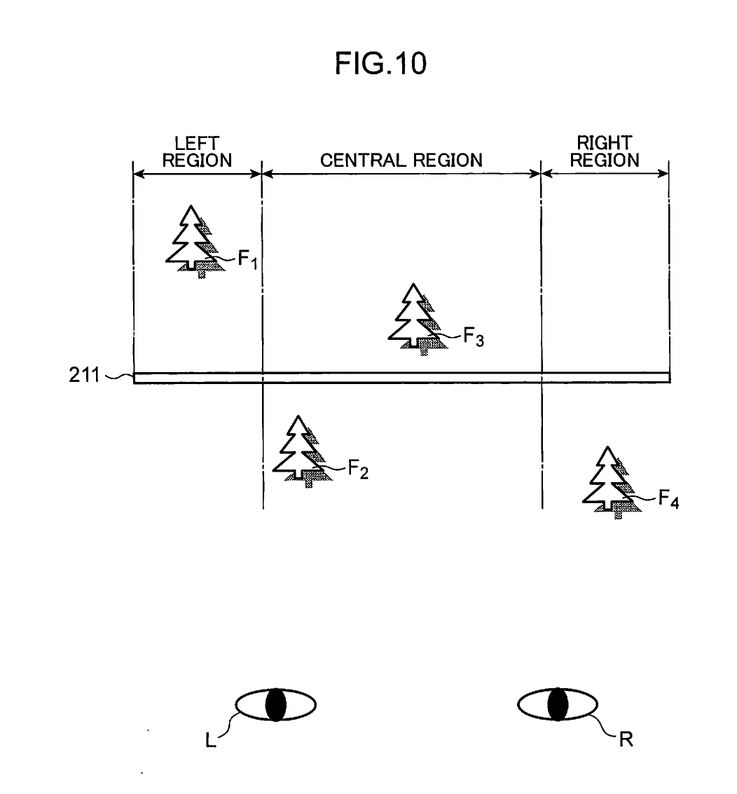

FIG. 10 shows another method for moving objects where several objects are stereoscopically perceived. The other method for moving the objects is described with reference to the sections (a) to (c) of FIG. 2, FIG. 3, the sections (a) to (d) of FIG. 7 and FIG. 10.

The object identification portion may select and move objects in response to the object display positions on the display panel 211. The object identification portion may identify the display region of the objects on the display panel 211 as three regions which are horizontally divided (left region, central region and right region) as shown in FIG. 10.

In FIG. 10, the object F₁ is displayed in the left region. The objects F₂, F₃ are displayed in the central region. The object F₄ is displayed in the left region.

The object identification portion selects and moves the objects F₂, F₃ displayed in the central region. The changing portion changes the display positions of the selected objects F₂, F₃ by means of the methodologies described with reference to the sections (a) to (c) of FIG. 2 and the sections (a) to (d) of FIG. 7. Generally, it is likely that the viewer gazes at objects displayed in the central region. Therefore, if the pop-up and/or deep-in volumes of an object displayed in the central region are reduced, there may be little strain on the viewer's eyes.

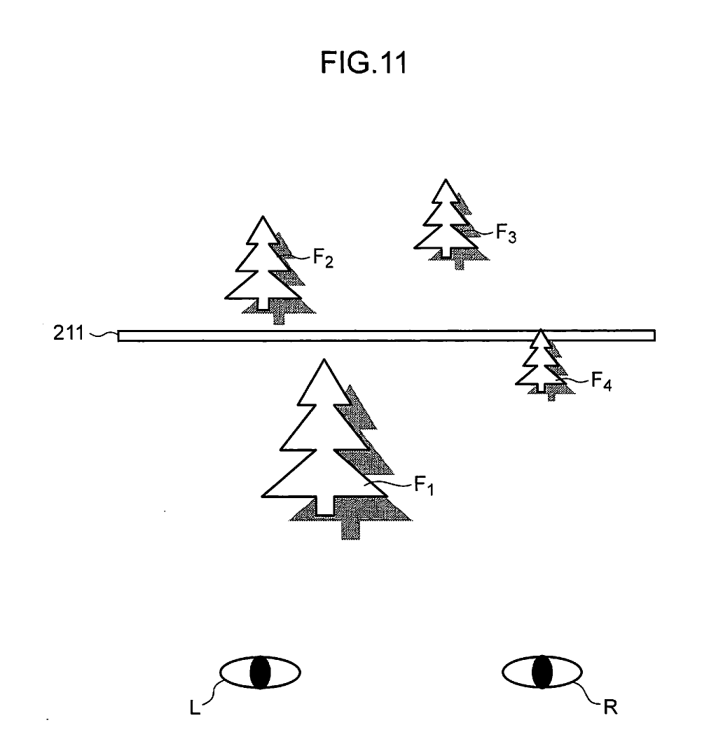

FIG. 11 shows another method for moving objects where several objects are stereoscopically perceived. The other method for moving the objects is described with reference to the sections (a) to (c) of FIG. 2, FIG. 3, the sections (a) to (d) of FIG. 7 and FIG. 11.

The object identification portion may select and move objects in response to the object display size on the display panel 211. FIG. 11 shows an object F₁ which is displayed in the largest size, an object F₂ which is displayed in the next largest size after the object F₁, an object F₃ which is displayed in the next largest size after the object F₂, and an object F₄ which is displayed in the largest size. The object identification portion may set a priority sequence associated with the display size of the objects, and then, for example, select two objects. In this case, the object identification portion selects the objects F₁, F₂.

The changing portion changes the display positions of the selected objects F₁, F₂ by means of the methodologies described with reference to the sections (a) to (c) of FIG. 2 and the sections (a) to (d) of FIG. 7. In general, it is likely that the viewer gazes at the object which is displayed in the largest size. Therefore, if the pop-up and/or deep-in volumes of objects displayed in a relatively large size are reduced, there may be little strain on the viewer's eyes.

The priority sequence used by the object identification portion described with reference to FIG. 11 may be applied to the methods for moving objects described with reference to FIGS. 9 and 10. For example, the methodologies of the change in the display of objects described with reference to FIG. 9 may be applied only to a prescribed number of objects, which are displayed in a large size, out of the objects F₃ to F₆ identified on the basis of the threshold values T₁, T₂. Alternatively, the methodologies of the change in the display of objects described with reference to FIG. 9 may be applied only to objects, which are displayed in the central region or at positions nearby the central region, out of the objects F₃ to F₆ identified on the basis of the threshold values T₁, T₂. Alternatively, the object identification portion may select and move a prescribed number of objects in response to a distance from the display panel 211 to the object as perceived by the viewer, a display position and/or a display size of the object.

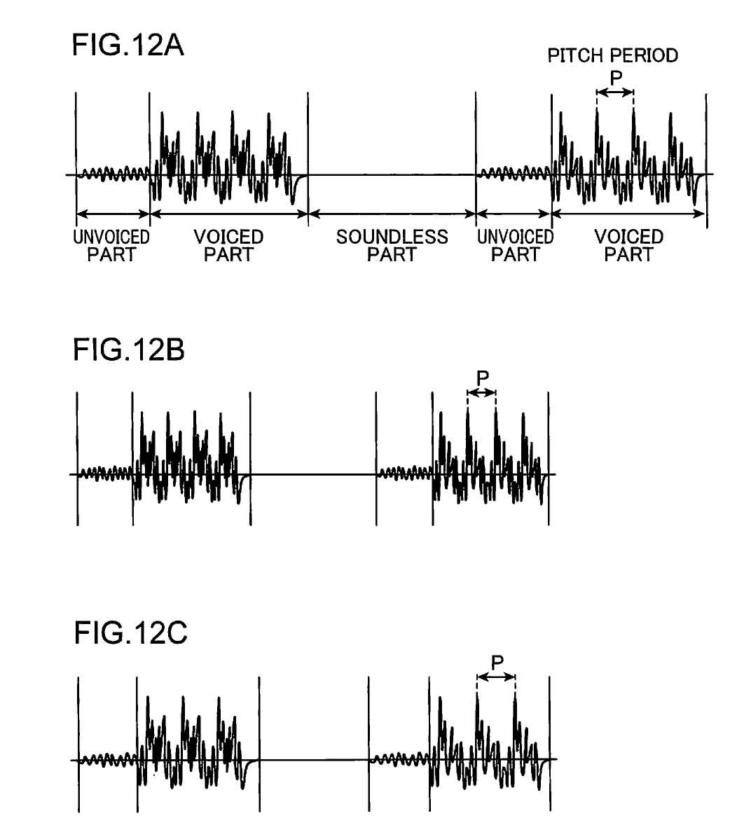

FIGS. 12A to 12C show audio signal processes of the audio signal processor 239 during the quick view playback. FIG. 12A shows audio data (sound signal) at the standard playback speed of the content data contained in the storage medium 233. FIG. 12B shows audio data (an audio signal) output from the playback portion 236 to the audio signal processor 239 during the quick view playback. FIG. 12C shows audio data (an audio signal) after the audio signal process by the audio signal processor 239. The audio signal process by the audio signal processor 239 is described with reference to FIG. 1, FIG. 3 and FIGS. 12A to 12C.

If the viewer operates the remote controller 25 to instruct the quick view playback, the playback portion 236 plays back all of the audio data in the content data contained in the storage medium 233 to output the audio data to the audio signal processor 239 like the playback at the standard playback speed. As a comparison between the audio data shown in FIGS. 12A and 12B clearly shows, the audio data played back at the quick view playback speed involves a greater volume of data per second than the audio data played back at standard playback speed. The audio signal processor 239 executes speed conversion processes to reduce the audio data volume to a data volume as large as that of the playback at the standard playback speed, and then output the audio data to the display device 21.

As shown in FIG. 12A, the audio data are divided into a soundless part, an unvoiced part which represents consonant sounds of a human voice, and a voiced part which represents vowel sounds of a human voice. A periodicity (pitch period) having uniform intervals is recognized in the voiced part. The audio signal processor 239 detects the pitch period P.

As shown in FIG. 12B, the audio data, which are played back at the quick view playback speed and output from the playback portion 236 to the audio signal processor 239, have a large data volume per second in comparison to the audio data which are played back at the standard playback speed, as described above. Therefore, the pitch period P of the audio data which are played back at the quick view playback speed becomes shorter than the pitch period P of the audio data which are played back at the standard playback speed. Thus, if the audio data played back at the quick view playback speed are output without the speed conversion process, the viewer may hear sound having a higher pitch because of the shortened pitch period P. The sound may be too fast for the viewer to grasp the content of the sound data.

As shown in FIG. 12C, the audio signal processor 239 adjusts the audio data during the playback at the quick view playback speed so as to shorten the soundless part and lengthen the unvoiced part and the voiced part in response to the quick view playback speed. Accordingly, the audio speed is reduced and facilitates the viewer to comprehend the content of the audio data. The audio signal processor 239 decreases the audio data of the voiced part every detected pitch period P, so as to make a length of the pitch period P equal or close to the pitch period of the audio data played back at the standard playback speed. The audio signal processor 239 appropriately decreases the audio data of the unvoiced part. The audio data of the unvoiced part and the voiced part are then adjusted to have the same or similar waveform as or to that of the audio data played back at the standard playback speed. Accordingly, the sound output from the display device 21 is the same as or similar to the sound played back at the standard playback speed.

Operation of the image playback device 23 during the fast playback mode is described with reference to FIGS. 1 and 3.

If the viewer operates the remote controller 25 to instruct the playback of the content data at the fast playback speed, the controller 235 controls the playback portion 236, the image signal processor 237, the adjuster 238, the medium controller 234, the image generator 241 and the audio signal processor 239 via the bus 240 to play back the content data (image data and audio data) from the storage medium 233 at the fast playback speed (e.g., a playback speed 2 times as high as the standard playback speed). The image signal playback portion 237 reduces the images in the video data to output the image data 371, 372 to the adjuster 238. Accordingly, the temporal changes in the parallax amount become greater.

The adjuster 238 outputs one of the left and right images data 381, 382 to the display device 21 during the playback of the content data at the fast playback speed. Accordingly, the display device 21 displays one of the left and right image data 381, 382. Alternatively, the image signal processor 237 may output one of the left and right image data 371, 372 to the adjuster 238. Consequently, the adjuster 238 outputs one of the left and right image data 381, 382 to the display device 21, so that the display device 21 displays one of the left and right image data 381, 382. Further alternatively, the adjuster 238 may adjust the left and right images so that the parallax amount between the left and right images becomes “0” by means of the methodologies described with reference to FIGS. 5 to 11.

If the content data are played back at the fast playback speed, the audio signal processor 239 executes processes for stopping the output of the audio signal to the display device 21. Alternatively, if the content data are played back at the fast playback speed, the playback portion 236 does not play back the audio data. Accordingly, the viewer views the video, which is two-dimensionally displayed on the display panel 211, without hearing sound.

As described above, the adjuster 238 outputs one of the left and right image signals to set the parallax amount to “0” during the fast playback mode. Thus, if the display device 21 and the eyeglass device 3 carry out the same operations as those during the normal playback mode and the quick view playback mode, the viewer may view a two-dimensional image. In this case, the mode control signal 242 described with reference to FIG. 3 is not required. On the other hand, if the mode control signal 242 is active, an image without parallax may be presented to the viewer although the stereoscopic image signal having parallax is output. The operation of the display device 21 and the eyeglass device 3 in such a case is described with reference to FIGS. 1, 3 and 4 hereinafter.

The synchronization signal generator 215 receives information about operation of the image playback device 23 under the fast playback mode by means of the mode control signal 242 to generate a synchronization signal, of which waveform is different from the waveform used for the quick view playback mode. The synchronization signal generator 215 generates the synchronization signal which causes the eyeglass device 3 to open and close the left and right filters 31 32 at the same timing during the fast playback mode. The transmitter 213 sends the synchronization signal to the receiver 34 of the eyeglass device 3.

The internal signal generator 38 of the eyeglass device 3 generates an internal signal for controlling the optical filter controller 39 to make the same image viewed by the left and right eyes, in response to the waveform of the synchronization signal. The optical filter controller 39 executes control for opening and closing the left and right filters 31, 32 at the same timing, in response to the internal signal. For example, if both filters open at the timing synchronized with the left image, the viewer views the left image with both the right and left eyes. Thus, the viewer views the video two-dimensionally displayed on the display panel 211.

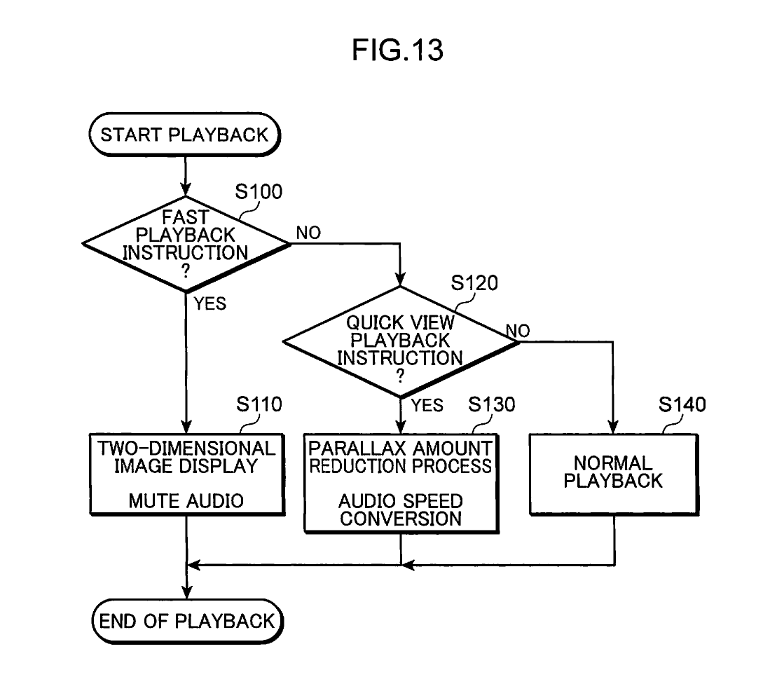

FIG. 13 is a flowchart showing the playback control by the controller 235. In the present embodiment, the controller 235 may be an image playback program which is stored in advance in the image playback device 23 to execute the playback control. The playback control by the controller 235 is described with reference to FIGS. 1, 3 and 13.

### (Step S100)

If the viewer operates the remote controller 25 to send a control signal to the image playback device 23, the controller 235 determines whether the fast playback mode is instructed in response to the control signal or not. If the controller 235 determines that the fast playback mode is instructed, step S110 is executed. Unless the controller 235 determines that the fast playback mode is instructed, step S120 is executed.

### (Step S110)

If the controller 235 determines that the fast playback mode is instructed, the controller 235 controls the playback portion 236, the image signal processor 237, the adjuster 238, the medium controller 234 and the image generator 241 via the bus 240 to play back the content data contained in the storage medium 233 at the fast playback speed.

As described above, if the content data are played back at the fast playback speed, the image signal processor 237 reduces the left and right image data 371, 372, respectively, under the control of the controller 235, and then outputs the data to the adjuster 238. The adjuster 238 outputs one of the left and right image data 381, 382 to the display device 21 under the control of the controller 235. Alternatively, the image signal processor 237 may output one of the left and right image data 371, 372 to the adjuster 238 under the control of the controller 235. The adjuster 238 may output one of the left and right image data 371, 372, which are output from the image signal processor 237, to the display device 21 under the control of the controller 235. Accordingly, the adjuster 238 outputs one of the left and right image data 371, 372 to the display device 21. The image data output from the adjuster 238 to the display device 21 may be determined in advance or through operations performed by the viewer using the remote controller 25.

The controller 235 also controls the playback portion 236 to stop the playback portion 236 from executing the playback of the audio data. Alternatively, the controller 235 may cause the playback portion 236 to play back the audio data while the controller 235 prevents the audio signal processor 239 from outputting the audio data. Accordingly, the viewer views the video two-dimensionally displayed on the display panel 211 without hearing sound.

### (Step S120)

In step 100, unless it is determined that the control signal indicates the fast playback mode, step 120 is executed. At step 120, the controller 235 determines whether or not the control signal indicates the playback of the content data at the quick view playback speed. If the controller 235 determines that the playback at the quick view playback speed is instructed, the step 130 is executed. Unless the controller 235 determines that the playback at the quick view playback speed is instructed, step 140 is executed.

### (Step S130)

If the controller 235 determines that the playback at the quick view playback speed is instructed, the controller 235 controls the playback portion 236, the image signal processor 237, the adjuster 238, the medium controller 234 and the image generator 241 via the bus 240 to play back the content data (video data and/or audio data) contained in the storage medium 233 at the quick view playback speed.

As described above, if the content data are played back at the quick view playback speed, the image signal processor 237 decreases the left and right image data 371, 372, respectively, under the control of the controller 235, and then outputs the data to the adjuster 238. The adjuster 238 then detects the parallax amount between the left and right image data 371, 372 under the control of the controller 235 to reduce the parallax amount. The decrease in the parallax amount is achieved by means of the methodologies described with reference to FIGS. 5 to 11. The controller 235 outputs the left and right image data 381, 382, which are adjusted so as to have a decreased parallax amount by the adjuster 238, to the display device 21. The controller 235 also controls the audio signal processor 239 to adjust the audio signal. The adjustment of the audio signal is achieved by means of the methodologies described with reference to FIGS. 12A to 12C. Accordingly, the viewer views the video stereoscopically displayed on the display panel 211 with sound. In this case, the pop-up and/or deep-in volumes of the object perceived by the viewer on the display panel 211 are reduced in comparison to the pop-up and/or deep-in volumes of the object perceived during the playback at the standard playback speed, as described above, which results in little strain on the eyes of the viewer watching the video played back at the quick view playback speed.

### (Step S140)

In step S120, unless the controller 235 determines that the control signal instructs the quick view playback, step S140 is executed. At step S140, the controller 235 controls the playback portion 236, the image signal processor 237, the adjuster 238, the medium controller 234 and the image generator 241 via the bus 240 to play back the content data (video data and/or audio data) contained in the storage medium 233 at the standard playback speed.

(Mode Change from Fast Playback Mode to Standard Playback Mode)

If the viewer operates the remote controller 25 to change the mode from the fast playback mode to the standard playback mode, the image signal processor 237 outputs frames of the image signals in the recording medium to the adjuster 238 without skipping under the control of the controller 235. The adjuster 238 outputs the left and right image data 381, 382 to the display device 21 under the control of the controller 235.

(Mode Change from Fast Playback Mode to Quick View Playback Mode)

If the viewer operates the remote controller 25 to change the mode from the fast playback mode to the quick view playback mode, the image signal processor 237 decreases the left and right image data 371, 372, respectively, and then outputs the data to the adjuster 238 under the control of the controller 235. The adjuster 238 then detects the parallax amount between the left and right image data 371, 372 under the control of the controller 235 to reduce the parallax amount. The decrease in the parallax amount is achieved by means of the methodologies described with reference to FIGS. 5 to 11. The controller 235 outputs the left and right image data 381, 382, which are adjusted so as to have a reduced parallax amount by the adjuster 238, to the display device 21. The controller 235 controls the audio signal processor 239 to adjust the audio signal. The adjustment of the audio signal is achieved by means of the methodologies described with reference to FIGS. 12A to 12C. Thus, the viewer views the video stereoscopically displayed on the display panel 211 with sound. In this case, the pop-up and/or deep-in volumes of the object perceived by the viewer on the display panel 211 are reduced in comparison to the pop-up and/or deep-in volumes of the object perceived during the playback at the standard playback speed, as described above, which results in little strain on the eyes of the viewer watching the video played back at the quick view playback speed.

(Mode Change from Quick View Playback Mode to Standard Playback Mode)

If the viewer operates the remote controller 25 to change the mode from the quick view playback mode to the fast playback mode, the image signal processor 237 outputs the frames of the image signals in the recording medium to the adjuster 238 without skipping under the control of the controller 235. The adjuster 238 outputs the left and right image data 381, 382 to the display device 21 under the control of the controller 235. In this case, the adjuster 238 does not adjust the parallax amount of the left and right image data 371, 372 which are input from the image signal processor 237. Therefore, there is a parallax amount between the left and right image data 381, 382, which are output from the adjuster 238 in response to the content data in the storage medium 233. Accordingly, in the standard playback mode, the viewer may view an object having large pop-up and/or deep-in volumes in comparison to the quick view playback mode.

### Second Embodiment

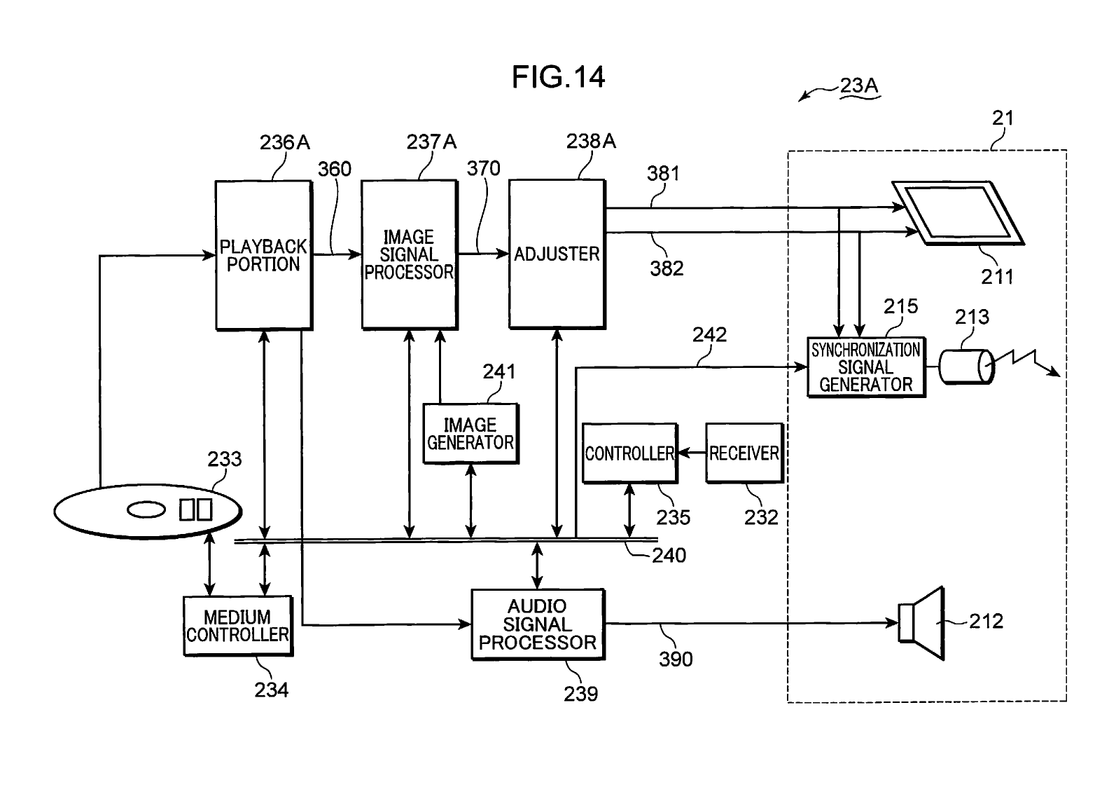

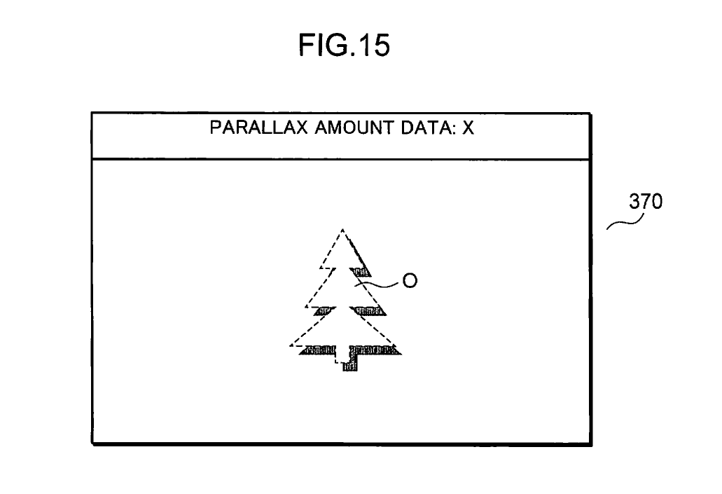

FIG. 14 is a schematic block diagram of a configuration of an image playback device 23A according to the second embodiment. FIG. 15 shows image data 360 which are output from the playback portion 236A. The same elements as the first embodiment are labeled with the same reference numerals. Differences from the first embodiment are described with reference to FIGS. 14 and 15. In the present embodiment, the image data 360, which are sent from the playback portion 236A to the adjuster 238A, are different from the first embodiment. The descriptions in the context of the first embodiment may be suitably applied to elements which are not described below.

Like the playback portion 236 described in the context of the first embodiment, the playback portion 236A reads out the image data, which are played back, from video data of the content data contained in the storage medium 233. The playback portion 236A then outputs the read image data 360 to the image signal processor 237A. The image data 360 include parallax amount data “X” to generate the left and right image data 381, 382, in addition to the image data displayed on the display panel 211.

Like the image signal processor 237 described in the context of the first embodiment, the image signal processor 237A applies expansion processes for compressive encoding such as MPEG-2 and H.264 during recording and adjustment processes for the image display to the image data 360. The image data 370 after these processes are output to the adjuster 238A.

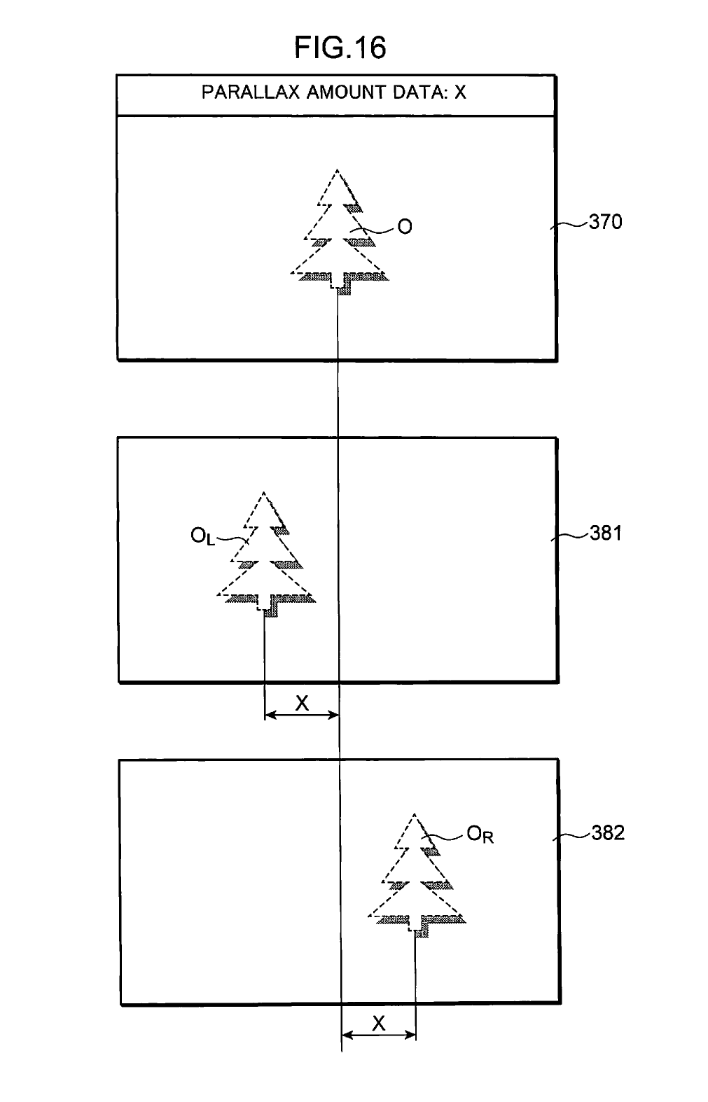

FIG. 16 shows the image data 370, which are output from the image signal processor 237A, and the left and right image data 381, 382 which are output from the adjuster 238A in the standard playback mode. The generation of the image data 381, 382 by the adjuster 238A is described with reference to FIGS. 14 and 16.

The adjuster 238A generates left and right image data 381, 382 in response to the image data 370 which are output from the image signal processor 237A. In the standard playback mode, the adjuster 238A generates the image data 381, 382, in which the display position of the object O in the image data 370 is shifted by a parallax amount “X”, in response to the parallax amount data included in the image data 370. The object is horizontally shifted but the shift direction is different between the left and right image data 381, 382.

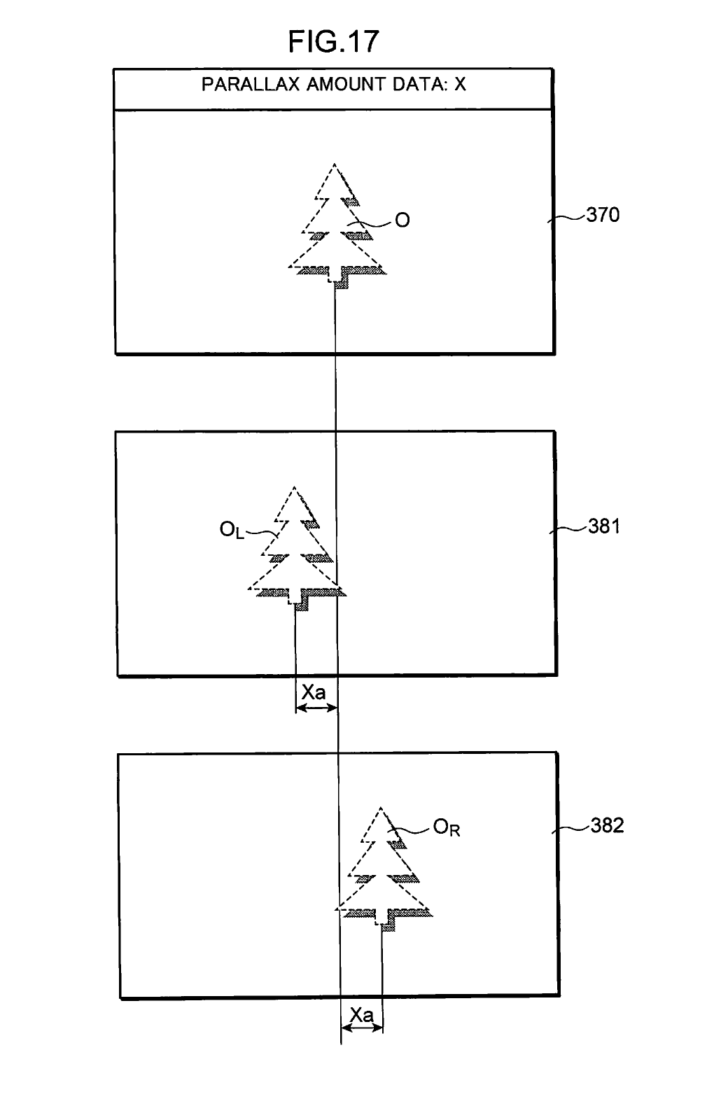

FIG. 17 shows the image data 370, which are output from the image signal processor 237A, and left and right image data 381, 382 which are output from the adjuster 238A in the quick view playback mode. The generation of the image data 381, 382 by the adjuster 238A is described with reference to FIGS. 14, 16 and 17.

The adjuster 238A generates the image data 381, 382, in which the display position of the object O in the image data 370 is horizontally shifted by a smaller parallax amount “Xa” than the parallax amount “X” defined by the parallax amount data of the image data 370. A reduction rate of the shift amount “Xa” of the display position of the object O in the quick view playback mode with respect to the shift amount “X” of the display position of the object O in the standard playback mode is appropriately determined in response to the play back speed difference between the standard playback mode and the quick view playback mode. In the present embodiment, the parallax amount data included in the image data 370 are exemplified as the parallax information. The methodologies described with reference to FIGS. 5 to 11 may be used for the display position adjustment of the objects in the quick view playback mode.

The adjuster 238A may reduce the image data 381, 382 so that the reduced parallax amount “Xa” is obtained in the quick view playback mode. Alternatively, if parallax amount data are assigned to the objects included in the image data 370, respectively, the adjuster 238A may individually shift the objects. Further alternatively, the adjuster 238A may select the objects to be moved in response to the parallax amount data allocated to each object.

In the second embodiment, the object O in the image data 370 is horizontally shifted in the image data 381, 382 in response to the parallax amount data of the image data 370. Alternatively, the parallax amount data included in the image data 370 may express a shift amount associated with one of the image data 381, 382. For example, if the parallax amount data in the image data 370 expresses a shift amount for the object O_{L} in the left image data 381, the adjuster 238A shifts the object O_{L} in response to the parallax amount data to generate the left image data 381. The adjuster 238A may depict the object O_{R} at a position substantially equal to the object O represented in the image data 370 to generate the right image data 382.

In the aforementioned embodiment, a speed of two or more times as high as the standard playback mode is exemplified as the fast playback mode. In the fast playback mode, the display panel 211 shows two-dimensional images. Alternatively, in a low rate fast playback at a playback speed of 2 times or 4 times as high as the standard playback speed, the viewer may view video images with a decreased parallax amount, which results from the methodologies described with reference to FIGS. 5 to 11. The video images which are two-dimensionally viewed by the viewer may be presented if the playback speed exceeds 4 times as high as the standard playback speed as described above.

In the first embodiment, the playback portion 236 reads in all of the images from the storage medium 233 during the fast playback. Alternatively, the playback portion 236 may selectively read in one of the left and right image data from the storage medium 233 during the fast playback.

In the aforementioned embodiment, an eyeglass device with a shutter system is employed as the eyeglass device 3 which assists in viewing the stereoscopic video images. Alternatively, an eyeglass device based on a deflection system may be used as the eyeglass device 3 which assists in viewing the stereoscopic video images.

The aforementioned image playback device 23 may comprise: a CPU (Central Processing Unit), a system LSI (Large Scale Integration), a RAM (Random Access Memory), a ROM (Read Only Memory), an HDD (Hard Disk Drive) and a network interface. The image playback device 23 may comprise a driver configured to read out and write information from and to a portable recording medium such as a DVD-RAM, Blu-ray disk or SD (Secure Digital) memory card.

The configurations, arrangements or shapes and alike depicted in the drawings and the descriptions with reference to the drawings are intended to explain the principles of the aforementioned embodiments, and do not in any way limit the principles of the aforementioned embodiments. The content data shown in the aforementioned embodiments include video data for video images and/or audio data, etc. which are contained in a storage medium such as a Blu ray disk or a DVD disk. Alternatively, the content data may be video data and/or audio data which are provided via the Internet, broadcast radio waves or by other means. The image playback device shown in the aforementioned embodiment is a Blu-ray player or a DVD player for playing back a storage medium such as a Blu-ray disk or a DVD disk. Alternatively, the image playback device may be a personal computer which plays back the provided content data with or without storing the content data, or any other device having an image playback function. In the aforementioned embodiment, the television device exemplified as the display device includes the display device for displaying content data as video images and the image playback device are provided as separate units. Alternatively, the television device may include a display device and an image playback device which are integrated together. Apart from a television device which has functions for tuning broadcast waves, the display device may be a computer having a monitor, or any other device configured to display images.

In the aforementioned embodiment, the standard playback speed which depends on the storage medium storing the content data is exemplified as the first speed. Alternatively, the best playback speed at which the content data is preferably presented may be exemplified as the first speed. Further alternatively, a relatively low playback speed of the playback speeds which are provided by the image playback device may be used as the first speed. In the above embodiment, the quick view playback speed, which is a playback speed faster than the first speed and allows the viewer to understand the contents of the audio data, is exemplified as the second speed. Alternatively, a playback speed which allows the viewer to stereoscopically perceive objects represented by the video data included in the content data may be exemplified as the second speed. In the above embodiment, the quick view playback speed is 1.3 to 1.5 times as high as the standard playback speed. Alternatively, the quick view playback speed may be set to be faster than the standard playback speed but less than 2 times as high as the standard playback speed. In the aforementioned embodiment, a fast playback speed which is faster than a playback speed that allows the viewer to understand the contents of the audio data is described as the third speed. Alternatively, any playback speed which is faster than the second speed may be used as the third speed. In the above embodiment, the fast playback speed is 2 times as high as the standard playback speed. Alternatively, the fast playback speed may be greater than 2 times as high as the standard playback speed or less than 2 times as high as the standard playback speed. Further alternatively, the playback speed may be continuously increased and decreased. In this case, any speed in a variation range of the continuously changeable playback speed is exemplified as the first speed, any speed faster than the first speed is exemplified as the second speed, and any speed faster than the second speed is exemplified as the third speed.

The image playback device 23 according to the present embodiment has a television device 2 with the display device 21. Alternatively, the image playback device 23 may be incorporated into any image processing device such as a digital video camera, a digital recorder, a digital television, a game machine, an IP telephone or a portable telephone.

The controller 235 and/or other constituent elements of the image playback device 23 according to the present embodiment may be realized as programs which are installed on a HDD or ROM or alike (hereinafter, such a program is called an image playback program) to control the image playback device 23. The functions of the image playback device 23 may be realized by executing the image playback program, respectively.

The image playback program may be recorded on a recording medium which is read by a hardware system such as a computer system or an embedded system. The image playback program may be read out to another hardware system via a recording medium to execute and achieve the functions of the image playback device 23, respectively, by means of another hardware system. An optical recording medium (e.g., CD-ROM), a magnetic recording medium (e.g., a hard disk), a magneto-optical recording medium (e.g., a MO or alike) or a semiconductor memory (e.g., a memory card) are exemplified as a recording medium read by a computer system.

The image playback program may be stored in a hardware system which is connected to a network such as the Internet or a local area network. The program may be downloaded and executed in another hardware system via a network. Therefore, the functions of the image playback device 23 are achieved by means of another hardware system, respectively. A terrestrial broadcast network, a satellite broadcast network, PLC (Power Line Communication), a mobile telephone network, a wired communication network (for example, IEEE 802.3) and a wireless communication network (for example, IEEE802.11) are exemplified as the network.

The functions of the image playback device 23 may be achieved, respectively, by means of an image playback circuit which is installed in the image playback device 23 according to the present embodiment.

The image playback circuit may be formed in a programmable logic device such as a full-custom LSI, a semi-custom LSI such as an ASIC (Application Specific Integrated Circuit), a programmable logic device such as a FPGA (Field Programmable Gate Array) or CP LD (Complex Programmable Logic Device) or a dynamic reconfigurable device of which the circuit configuration is dynamically rewritten.

Design data for defining functions of the image playback device 23 in the image playback circuit, respectively, may be a program which is written in a hardware description language (hereinafter, called HDL program). Alternatively, the design data may be a gate-level net list which obtains an HDL program by logical synthesis. The design data may be macro cell information formed by adding layout information, process conditions and alike to a gate-level net list. The design data may be mask data which define dimensions, timings and alike. The exemplary hardware description language may be VHDL (Very High-speed integrated circuit Hardware Description Language), Verilog-HDL and SystemC.

The design data may be recorded on a recording medium which is read by a hardware system such as a computer system or an embedded system. The design data may be read out to another hardware system via a recording medium for the execution. The design data read into the other hardware system via the recording media may be downloaded to a programmable logic device via a download cable.

The design data may be stored in a hardware system which is connected to a network such as the Internet or a local area network. The design data may be downloaded and executed in another hardware system via a network. The design data acquired in another hardware system via such a network may be downloaded to a programmable logic device via a download cable.

Alternatively, the design data may be recorded on a serial ROM, so as to be transferable to an FPGA if current is passed. The design data recorded on the serial ROM may be directly downloaded onto a FPGA if current is passed.

The design data may be generated by a microprocessor and downloaded to a FPGA if current is passed.

The aforementioned embodiments mainly have the following configurations.

The image playback device according to one aspect of the aforementioned embodiments comprises: a playback portion which plays back content data to make a video stereoscopically viewed by means of video data including a first image for a first view point and a second image for a second view point; a setting portion configured to set a playback speed for playing back the content data; and an adjuster configured to adjust parallax information about parallax between the first and second images in response to the playback speed set by the setting portion.

According to the above configuration, the content data played back by the playback portion make the video stereoscopically viewed by means of the video data including the first and second images for the first and second view points, respectively. The setting portion sets the playback speed for playing back the content data. The adjuster adjusts the parallax information about the parallax between the first and second images in response to the playback speed set by the setting portion. Since the parallax information is adjusted in response to the playback speed, it becomes less likely that the viewer's eyes increasingly fatigue even if the content data are played back at a high playback speed so that the viewer may comprehend the details of the content in a relatively short time.

In the aforementioned configuration, preferably, the adjuster changes at least one perception volume of a pop-up volume and a deep-in volume of an object in the video data, which are perceived by a viewer viewing the content data, in response to the playback speed.

According to the aforementioned configuration, the adjuster changes the at least one perception volume of the pop-up or deep-in volume of an object in the video data, which are perceived by a viewer viewing the content data, in response to the playback speed. Consequently, even if the content data are played back at a high playback speed so that the viewer may comprehend the content details in a relatively short time, it becomes less likely that the viewer's eyes increasingly fatigue.

In the above configuration, preferably, the setting portion selectively sets a first mode for playing back the content data at a first speed, and a second mode for playing back the content data at a second speed which is faster than the first speed, and the adjuster adjusts the parallax information so that a change amount of the perception volume in the second mode is less than a change amount of the perception volume in the first mode.

According to the above configuration, the setting portion selectively sets the first mode for playing back the content data at the first speed and the second mode for playing back the content data at the second speed, which is faster than the first speed. The adjuster adjusts the parallax information so that the change amount in the perception volume in the second mode becomes smaller than the change amount in the perception volume in the first mode. In the second mode, the change amount of the perception volume becomes smaller to moderate strain on the viewer's eyes. The viewer viewing the first and second images of the content data in the second mode may stereoscopically perceive the video to comprehend the content details in a short time.

In the aforementioned configuration, preferably, the adjuster shifts at least one of the first and second images.

According to the above configuration, the adjuster, which adjusts the parallax information, shifts at least one of the first and second images. In the second mode, the viewer views the content data, in which the change amount in the perception volume is reduced in comparison to the change amount of the perception volume in the first mode to moderate strain on the viewer's eyes. The viewer viewing the first and second images of the content data in the second mode may stereoscopically perceive the video to comprehend the content details in a short time.

In the aforementioned configuration, preferably, the adjuster lessens the first and second images.

According to the aforementioned configuration, the adjuster, which adjusts the parallax information, lessens the first and second images. In the second mode, the viewer views the content data, in which the change amount in the perception volume is reduced in comparison to the change amount of the perception volume in the first mode to moderate strain on the viewer's eyes. The viewer viewing the first and second images of the content data in the second mode may stereoscopically perceive the video to comprehend the content details in a short time.

In the aforementioned configuration, preferably, the adjuster changes at least one of display positions of the object in the first and second images.

According to the aforementioned configuration, the adjuster, which adjusts the parallax information, changes at least one of the positions of the object in the first and second images. In the second mode, the viewer views the content data, in which the change amount in the perception volume is reduced in comparison to the change amount of the perception volume in the first mode to moderate strain on the viewer's eyes. The viewer viewing the first and second images of the content data in the second mode may stereoscopically perceive the video to comprehend the content details in a short time.

In the aforementioned configuration, preferably, the object includes a plurality of objects, and the adjuster selects an object to change the display position of the object based on the pop-up volume from a display surface to display the content data, the deep-in volume from the display surface, a display position of the object on the display surface and a display size of the object.

According to the above configuration, if the first and second images render several objects, the adjuster selects one object to change the display position of the object. The object is selected on the basis of at least one of the pop-up volume of the object from a display surface to display the content data, the deep-in volume of the object from the display surface, the display position of the object on the display surface and the display size of the object, which results in efficient and effective moderation of strain on the viewer's eyes.

In the aforementioned configuration, preferably, the adjuster includes: a segmentation portion configured to divide the first and second images into image segments, respectively; an image segment identification portion configured to identify image segments, which contribute to display of the object, among the image segments; and a changing portion configured to change a display position of image data included in the image segments which contribute to the display of the object.

According to the above configuration, the segmentation portion of the adjuster divides the first and second images, respectively, into several image segments. The image segment identification portion identifies the image segments which contribute to the display of the object. The changing portion changes the display position of the image data included in the image segments which contribute to the display of the object. In the second mode, the viewer views the content data in which the change amount in the perception volume is reduced in comparison to the change amount of the perception volume in the first mode to moderate strain on the viewer's eyes. The viewer viewing the first and second images of the content data in the second mode may stereoscopically perceive the video to comprehend the content details in a short time.

In the aforementioned configuration, preferably, the adjuster adjusts the parallax information so as to reduce an absolute value of a difference between a reference convergence angle of the first and second view points with respect to a display surface, on which the content data are displayed, and a convergence angle of the first and second view points with respect to the object included in the first and second images.

According to the aforementioned configuration, the adjuster adjusts the parallax information so as to reduce the absolute value of the difference between the reference convergence angle of the first and second view points with respect to the display surface on which the content data are displayed, and the convergence angle of the first and second view points with respect to the object included in the first and second images. In the second mode, the viewer views the content data in which the change amount in the perception volume is reduced in comparison to the change amount of the perception volume in the first mode to moderate strain on the viewer's eyes. The viewer viewing the first and second images of the content data in the second mode may stereoscopically perceive the video to comprehend the content details in a short time.

In the above configuration, preferably, the parallax information includes information about a difference between display positions of an object in the first and second images, and the adjuster adjusts the parallax information so as to reduce the difference in the display positions of the object between the first and second images.

According to the above configuration, the parallax information has the information about the difference between the display positions of the object in the first and second images. The adjuster adjusts the parallax information so as to reduce the difference in the display position of the object between the first and second images. In the second mode, the viewer views the content data in which the change amount in the perception volume is reduced in comparison to the change amount of the perception volume in the first mode to moderate strain on the viewer's eyes. The viewer viewing the first and second images of the content data in the second mode may stereoscopically perceive the video to comprehend the content details in a short time.

In the above configuration, preferably, the setting portion sets a third mode for playing back the content data at a third speed which is faster than the second speed, and the adjuster outputs one of the first and second images in the third mode.

According to the aforementioned configuration, in the third mode, the adjuster outputs one of the first and second images to play back the content data as a two-dimensional video.

In the aforementioned configuration, preferably, the image playback device further comprises an audio signal processor; and the content data include audio data; the playback portion plays back the audio data if the setting portion sets the playback speed of the content data to the first or second mode; the audio signal processor adjusts the audio data in response to the second speed, if the setting portion sets the playback speed of the content data to the second mode; and the playback portion does not play back the audio data, if the setting portion sets the playback speed of the content data to the third mode.

According to the aforementioned configuration, the playback portion plays back the audio data if the setting portion sets the playback speed of the content data to the first or second mode. If the controller sets the playback speed of the content data to the second mode, the audio signal processor adjusts the audio data in response to the second speed. If the controller sets the playback speed of the content data to the third mode, the playback portion does not play back the audio data. Thus, the viewer may hear the audio data and view content data in the first or second mode. In the third mode, the viewer views two-dimensional images without hearing sound.

The display apparatus according to another aspect of the aforementioned embodiments comprises: a playback portion which plays back content data to make a video stereoscopically viewed by means of video data including a first image for a first view point and a second image for a second view point; a display portion configured to display the video data; a setting portion configured to set a playback speed for playing back the content data; and an adjuster configured to adjust parallax information about parallax between the first and second images in response to the playback speed set by the setting portion.

According to the above configuration, the display portion configured to display content data, which are played back by the playback portion, may make the video stereoscopically viewed by means of the video data including the first and second images for the first and second view points, respectively. The setting portion sets the playback speed for playing back the content data. The adjuster adjusts the parallax information about the parallax between the first and second images in response to the playback speed set by the setting portion. Since the parallax information is adjusted in response to the playback speed, it becomes less likely that the viewer's eyes increasingly fatigue even if the content data are played back at a high playback speed so that the viewer may comprehend the details of the content in a relatively short time.

In the aforementioned configuration, preferably, the setting portion selectively sets a first mode for playing back the content data at a first speed, a second mode for playing back the content data at a second speed, which is faster than the first speed, and a third mode for playing back the content data at a third speed, which is faster than the second speed, and the adjuster causes the display portion to display only one of the first and second images in the third mode.

According to the aforementioned configuration, if content data are played back at the third speed, the viewer may two-dimensionally view the content data.

An image playback program for playing back content data to make a video stereoscopically viewed by means of video data including a first image for a first view point and a second image for a second view point, according to yet another aspect of the present invention causes an image playback device which plays back the content data to perform: a function of selecting a first mode for playing back the content data at a first speed, or a second mode for playing back the content data at a second speed, which is faster than the first speed; and a function of making an change amount of at least one perception volume of a pop-up volume or a deep-in volume of an object in the video, which is viewed by the viewer viewing the content data in the second mode, smaller than a change amount in the first mode.

According to the above configuration, the content data played back by the image playback program makes the video stereoscopically viewed by means of video data including the first and second images for the first and second view points. The image playback program may select the first and second modes for playing back the content data at the first speed or the second speed, which is faster than the first speed. In the second mode, the viewer views content data, in which the change amount in the perception volume is reduced in comparison to the change amount of the perception volume in the first mode to moderate strain on the viewer's eyes. The viewer viewing the first and second images of the content data in the second mode may stereoscopically perceive the video to comprehend the content details in a short time.

### INDUSTRIAL APPLICABILITY

The principles according to the aforementioned embodiments may be used in an image playback device which plays back stereoscopic images and audio recorded on a recording medium. The aforementioned principles may be suitably used for a video player which plays back stereoscopic images from a recording medium such as a semiconductor memory or optical disk. The video player according to the aforementioned principles may cause few temporal changes in the parallax amount to suppress eye strain under quick view playback (for example, 1.3 times as high as a normal speed) or semi-fast playback.

1. An image playback device, comprising:
a playback portion which plays back content data to make a video stereoscopically viewed by means of video data including a first image for a first view point and a second image for a second view point;
a setting portion configured to set a playback speed for playing back the content data; and
an adjuster configured to adjust parallax information about parallax between the first and second images in response to the playback speed set by the setting portion.

2. The image playback device according to claim 1, wherein
the adjuster changes at least one perception volume of a pop-up volume and a deep-in volume of an object in the video data, which are perceived by a viewer viewing the content data, in response to the playback speed.

3. The image playback device according to claim 2, wherein
the setting portion selectively sets a first mode for playing back the content data at a first speed, and a second mode for playing back the content data at a second speed which is faster than the first speed, and
the adjuster adjusts the parallax information so that a change amount of the perception volume in the second mode is less than a change amount of the perception volume in the first mode.

4. The image playback device according to claim 3, wherein
the adjuster shifts at least one of the first and second images.

5. The image playback device according to claim 3, wherein
the adjuster lessens the first and second images.

6. The image playback device according to claim 3, wherein
the adjuster changes at least one of display positions of the object in the first and second images.

7. The image playback device according to claim 6, wherein
the object includes a plurality of objects, and
the adjuster selects an object to change the display position of the object based on the pop-up volume from a display surface to display the content data, the deep-in volume from the display surface, a display position of the object on the display surface and a display size of the object.

8. The image playback device according to claim 6, wherein
the adjuster includes:
a segmentation portion configured to divide the first and second images into image segments, respectively;
an image segment identification portion configured to identify image segments, which contribute to display of the object, among the image segments; and
a changing portion configured to change a display position of image data included in the image segments which contribute to the display of the object.

9. The image playback device according to claim 3, wherein
the adjuster adjusts the parallax information so as to reduce an absolute value of a difference between a reference convergence angle of the first and second view points with respect to a display surface, on which the content data are displayed, and a convergence angle of the first and second view points with respect to the object included in the first and second images.

10. The image playback device according to claim 3, wherein
the parallax information includes information about a difference between display positions of an object in the first and second images, and
the adjuster adjusts the parallax information so as to reduce the difference in the display positions of the object between the first and second images.

11. The image playback device according to claim 3, wherein
the setting portion sets a third mode for playing back the content data at a third speed which is faster than the second speed, and
the adjuster outputs one of the first and second images in the third mode.

12. A display device, comprising:
a playback portion which plays back content data to make a video stereoscopically viewed by means of video data including a first image for a first view point and a second image for a second view point;
a display portion configured to display the video data;
a setting portion configured to set a playback speed for playing back the content data; and
an adjuster configured to adjust parallax information about parallax between the first and second images in response to the playback speed set by the setting portion.

13. The display device according to claim 12, wherein
the setting portion selectively sets a first mode for playing back the content data at a first speed, a second mode for playing back the content data at a second speed, which is faster than the first speed, and a third mode for playing back the content data at a third speed, which is faster than the second speed, and
the adjuster causes the display portion to display only one of the first and second images in the third mode.
